(19) United States
(12) Patent Application Publication
(10) Pub. No.: US 2026/0260153 A1
(43) Pub. Date: Sep. 3, 2026

(54) CHARACTERIZATION USING NON-CONVENTIONAL MODALITIES OF COMPUTATION

(71) Applicant: Yudong Cao, Cambridge, MA (US)

(72) Inventor: Yudong Cao, Cambridge, MA (US)

(21) Appl. No.: 19/552,691

(22) Filed: Feb. 27, 2026

Related U.S. Application Data
(60) Provisional application No. 63/764,833, filed on Feb. 28, 2025.

(51) Int. Cl. G06N 10/70; G06F 8/41

(52) U.S. Cl. CPC G06N 10/70; G06F 8/443

(57) ABSTRACT

One or more properties of a quantum error correction protocol are specified in a formal language using a theorem prover. A quantum error correction protocol and a formal proof certificate are synthesized, the formal proof certificate being a machine-checkable proof that the quantum error correction protocol satisfies the one or more properties. The quantum error correction protocol is compiled into a quantum circuit with the formal proof certificate embedded in the quantum circuit. The quantum circuit is deployed onto quantum computing hardware.

### CROSS REFERENCE TO RELATED APPLICATIONS

This application claims the benefit of U.S. Provisional Patent Application Ser. No. 63/764,833, filed Feb. 28, 2025, the entire disclosure of which is hereby incorporated herein by reference.

### TECHNICAL FIELD

This disclosure relates to utilizing non-conventional modalities of computation for a plurality of uses including, for example, benchmarking application performance, characterizing application utility, leveraging formal methods, embedding applications within hardware architectures, and utilizing probabilistic computing hardware for various computational tasks such as optimization, reinforcement learning, cryptography, and scientific discovery.

### BACKGROUND

Modern computational challenges span a diverse range of fields, including artificial intelligence, scientific discovery, optimization, and cryptography. Many of these challenges involve processing and analyzing vast amounts of data, solving high-dimensional mathematical problems, and making real-time decisions under uncertainty. However, conventional computing architectures, such as CPUs and GPUs, often struggle with these demands due to their inherent limitations in efficiency, scalability, and energy consumption. These challenges highlight the need for innovative approaches to computation that can overcome the limitations of traditional architectures, enabling more efficient problem-solving in high-complexity domains.

### SUMMARY

In one embodiment, a method is provided. In this embodiment, the method includes specifying, using a theorem prover, one or more properties of a quantum error correction protocol in a formal language, synthesizing a quantum error correction protocol and a formal proof certificate, the formal proof certificate being a machine-checkable proof that the quantum error correction protocol satisfies the one or more properties, compiling the quantum error correction protocol into a quantum circuit with the formal proof certificate embedded in the quantum circuit, and deploying the quantum circuit onto quantum computing hardware.

In another embodiment, a system is provided. In this embodiment, the system includes a processor and a memory storing instructions that, when executed by the processor, cause the system to specify, using a theorem prover, one or more properties of a quantum error correction protocol in a formal language, synthesize a quantum error correction protocol and a formal proof certificate, the formal proof certificate being a machine-checkable proof that the quantum error correction protocol satisfies the one or more properties, compile the quantum error correction protocol into a quantum circuit with the formal proof certificate embedded in the quantum circuit, and deploy the quantum circuit onto quantum computing hardware.

In yet another embodiment, a non-transitory computer-readable medium is provided. In this embodiment, the non-transitory computer-readable medium stores instructions that, when executed by a processor, cause the processor to specify, using a theorem prover, one or more properties of a quantum error correction protocol in a formal language, synthesize a quantum error correction protocol and a formal proof certificate, the formal proof certificate being a machine-checkable proof that the quantum error correction protocol satisfies the one or more properties, compile the quantum error correction protocol into a quantum circuit with the formal proof certificate embedded in the quantum circuit, and deploy the quantum circuit onto quantum computing hardware.

In a further embodiment, a method is provided. In this embodiment, the method includes receiving a computational task, determining an energy function that maps configurations of variables to energy values, wherein the energy function encodes a structure of the computational task as a probability distribution, configuring a probabilistic computing device with parameters of the energy function, wherein the probabilistic computing device includes hardware that natively generates samples from the probability distribution, generating, by the probabilistic computing device, a plurality of samples from the probability distribution, and determining a result of the computational task based on the plurality of samples.

In still another embodiment, a system is provided. In this embodiment, the system includes a probabilistic computing device including hardware that natively generates samples from a probability distribution, and a processor coupled to the probabilistic computing device. The processor is configured to receive a computational task, determine an energy function that maps configurations of variables to energy values, wherein the energy function encodes a structure of the computational task as the probability distribution, configure the probabilistic computing device with parameters of the energy function, cause the probabilistic computing device to generate a plurality of samples from the probability distribution, and determine a result of the computational task based on the plurality of samples.

In an additional embodiment, a non-transitory computer-readable medium is provided. In this embodiment, the non-transitory computer-readable medium stores instructions that, when executed by a processor coupled to a probabilistic computing device, cause the processor to receive a computational task, determine an energy function that maps configurations of variables to energy values, wherein the energy function encodes a structure of the computational task as a probability distribution, configure the probabilistic computing device with parameters of the energy function, wherein the probabilistic computing device includes hardware that natively generates samples from the probability distribution, cause the probabilistic computing device to generate a plurality of samples from the probability distribution, and determine a result of the computational task based on the plurality of samples.

In one embodiment, a method is provided. In this embodiment, the method includes receiving, by a computing platform, a hardware specification describing capabilities of a non-conventional computing device, mapping the hardware specification to a resource envelope defining computational resource budgets supportable by the non-conventional computing device, evaluating a plurality of application instances against the resource envelope to identify application instances having resource requirements within the resource envelope, and outputting an indication of the identified application instances as computational tasks that the non-conventional computing device is capable of executing.

In another embodiment, a system is provided. In this embodiment, the system includes a processor and a memory storing instructions that, when executed by the processor, cause the system to receive a hardware specification describing capabilities of a non-conventional computing device, map the hardware specification to a resource envelope defining computational resource budgets supportable by the non-conventional computing device, evaluate a plurality of application instances against the resource envelope to identify application instances having resource requirements within the resource envelope, and output an indication of the identified application instances as computational tasks that the non-conventional computing device is capable of executing.

In yet another embodiment, a non-transitory computer-readable medium is provided. In this embodiment, the non-transitory computer-readable medium stores instructions that, when executed by a processor, cause the processor to receive a hardware specification describing capabilities of a non-conventional computing device, map the hardware specification to a resource envelope defining computational resource budgets supportable by the non-conventional computing device, evaluate a plurality of application instances against the resource envelope to identify application instances having resource requirements within the resource envelope, and output an indication of the identified application instances as computational tasks that the non-conventional computing device is capable of executing.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of a computing environment, in accordance with certain embodiments of the present disclosure.

FIG. 2 is a block diagram of a computing device, in accordance with certain embodiments of the present disclosure.

FIG. 3 is a data flow diagram of a benchmarking and resource estimation platform, in accordance with certain embodiments of the present disclosure.

FIG. 4 is a flow diagram of a method for proof-carrying quantum error correction, in accordance with certain embodiments of the present disclosure.

FIG. 5 is a flow diagram of a method for Gibbs sampling using a probabilistic computing device, in accordance with certain embodiments of the present disclosure.

FIG. 6 is a flow diagram of a method for simulated annealing using a probabilistic computing device, in accordance with certain embodiments of the present disclosure.

FIG. 7 is a flow diagram of a method for parallel tempering using a probabilistic computing device, in accordance with certain embodiments of the present disclosure.

FIG. 8 is a flow diagram of a method for hybrid adaptive sampling using a probabilistic computing device, in accordance with certain embodiments of the present disclosure.

FIG. 9 is a flow diagram of a technique for synthesizing and deploying a quantum error correction protocol with a formal proof certificate, in accordance with certain embodiments of the present disclosure.

FIG. 10 is a flow diagram of a technique for performing a computational task using a probabilistic computing device, in accordance with certain embodiments of the present disclosure.

FIG. 11 is a flow diagram of a technique for evaluating application instances against a resource envelope of a non-conventional computing device, in accordance with certain embodiments of the present disclosure.

FIG. 12 is a flowchart of an example of a technique associated with non-conventional modalities of computation, in accordance with implementations of the present disclosure.

FIG. 13 is a flowchart of an example of a technique associated with non-conventional modalities of computation, in accordance with implementations of the present disclosure.

### DETAILED DESCRIPTION

Modern computers operate by executing sequences of deterministic instructions on conventional processor architectures, including central processing units (CPUs) and graphics processing units (GPUs). These architectures process information by switching billions of transistors between binary states at high speed. While remarkably versatile, conventional processors encounter fundamental limitations when applied to certain classes of computational problems. Some problems involve solution spaces so large that exhaustive search exceeds the practical capabilities of any conventional processor. Other problems involve generating large numbers of random samples from probability distributions, a task that conventional processors perform slowly because the randomness is simulated in software rather than generated natively by the hardware. Still other problems involve simulating quantum mechanical phenomena, which conventional hardware may not perform efficiently because the number of quantum states grows exponentially with system size.

These limitations have motivated the development of non-conventional computing devices, defined as hardware architectures that differ from CPUs and GPUs in their fundamental approach to computation. Two categories of non-conventional computing devices are of particular relevance. The first category is quantum computing hardware (which may also be referred to as quantum computing devices, quantum processors, or quantum computers), which exploits quantum mechanical phenomena such as superposition, entanglement, and interference to process information in ways that have no classical analogue. Quantum computing hardware may be implemented using gate-model architectures, quantum annealing architectures, or measurement-based architectures, among other physical implementations including superconducting qubits, trapped ions, photonic systems, and topological qubits. The second category is a probabilistic computing device (which may also be referred to as a probabilistic computing chip, a special-purpose classical sampling device, or a probabilistic hardware accelerator), which is a classical hardware device whose physical architecture natively generates samples from probability distributions. Unlike quantum computing hardware, a probabilistic computing device is not a quantum device. Rather, a probabilistic computing device is a special-purpose classical device engineered so that the physical behavior of the hardware corresponds to sampling from an energy-based probability distribution.

Despite advances in fabricating non-conventional computing devices, a gap persists between the raw physical capabilities of these devices and the practical methods needed to make them useful for real-world computational tasks. This gap manifests in three distinct ways.

First, there is a characterization gap in the relationship between non-conventional computing hardware and the computational tasks it may address. Hardware specifications for quantum computing devices are typically expressed in terms of qubit counts, gate fidelities, connectivity graphs, and coherence times. Computational tasks, in contrast, are expressed in terms of algorithmic primitives, problem sizes, and accuracy requirements. The mapping between these two representations is non-trivial and currently requires deep domain expertise for each hardware-task pair. Existing resource estimation tools perform forward analysis, in which an application instance (that is, a specific computational task intended for execution on a non-conventional computing platform) is compiled into a hardware-level representation and the resource requirements are counted. However, no systematic tool exists for inverse analysis: given a hardware specification describing the capabilities of a non-conventional computing device, determining what computational tasks that device is capable of executing. This lack of bidirectional characterization means that hardware vendors may not be able to clearly communicate the practical utility of their devices, application developers may not be able to determine what hardware they need, and investment decisions about hardware development may lack rigorous quantitative grounding.

Second, there is a reliability gap in quantum error correction. Quantum computing hardware is inherently noisy. Decoherence and gate errors accumulate during computation, and without error correction, useful quantum computation is limited to trivial circuit depths. Quantum error correction (QEC) protocols, including stabilizer codes, concatenated codes, and topological codes, have been developed to address this problem. A quantum error correction protocol (which may also be referred to as a QEC protocol, a quantum error correcting code, or an error correction module) defines the procedures by which quantum information is encoded, errors are detected through stabilizer measurements, and corrections are applied. In some implementations, a quantum error correction protocol may define a stabilizer measurement schedule, encoding circuits, and decoding circuits. Existing QEC protocols are typically validated through simulation under assumed noise models, but they lack formal verification. There is no machine-checkable guarantee that a deployed protocol satisfies its stated fault-tolerance properties under the actual noise conditions of the hardware on which it operates. This gap is compounded by the fact that quantum hardware noise characteristics fluctuate over time, meaning that a protocol that performed adequately under one set of conditions may not perform adequately when conditions change. The consequence of undetected QEC failure is corrupted computation, in which wrong answers are produced without any indication that an error has occurred.

Third, there is a sampling bottleneck that limits the practical utility of probabilistic computing devices. Abroad class of computational problems, including high-dimensional integration, combinatorial optimization, model distillation, Bayesian inference, and generative modeling, fundamentally involves generating samples from probability distributions. On conventional hardware, this sampling is performed in software using pseudo-random number generators and iterative algorithms such as Markov Chain Monte Carlo (MCMC) methods. Software-based sampling is inherently slow for high-dimensional or multi-modal distributions because each sample is generated sequentially through an iterative process. A probabilistic computing device that natively generates samples from probability distributions offers the potential for substantial acceleration of these tasks, but realizing that potential requires systematic methods for mapping each computational task onto the device's native sampling framework. Without such methods, the hardware capability remains disconnected from the computational tasks it may accelerate.

Implementations of this disclosure address problems such as these by providing, in one aspect, a proof-carrying quantum error correction framework in which a quantum error correction protocol is formally specified, synthesized together with a machine-checkable formal proof certificate, compiled into a quantum circuit with the certificate embedded, and deployed onto quantum computing hardware. In another aspect, implementations of this disclosure provide a computational acceleration framework in which a probabilistic computing device is configured with an energy function that encodes the structure of a computational task as a probability distribution, and the device natively generates samples from that distribution to produce a result for the task. In yet another aspect, implementations of this disclosure provide a bidirectional characterization platform that performs both forward analysis (mapping a computational task to a hardware specification) and inverse analysis (mapping a hardware specification to the computational tasks a device may address).

The proof-carrying quantum error correction framework begins with a design-time process in which one or more properties of a quantum error correction protocol are specified in a formal language using a theorem prover (which may also be referred to as a proof assistant, a formal verification engine, or an automated reasoning system). A theorem prover is a software tool, either automated or interactive, designed to construct, verify, or discover formal mathematical proofs using logical deduction. Examples of theorem provers include, but are not limited to, Lean, Coq, and Isabelle. The formal language used within the theorem prover is tailored to express quantum information concepts with mathematical precision. The one or more properties specified using the theorem prover may include fault-tolerance of the quantum error correction protocol under a specified noise model (that is, the property that the protocol continues to correct errors when the hardware exhibits noise at or below a stated threshold), correctness of an encoding map (that is, the property that quantum information is correctly mapped from a logical representation to a physical representation), and correctness of a decoding map (that is, the property that quantum information is correctly recovered from the physical representation back to the logical representation). In some implementations, the one or more properties may further include adherence to specific error thresholds as stated by the quantum threshold theorem.

Once the one or more properties have been specified, the framework synthesizes a quantum error correction protocol and a formal proof certificate. The formal proof certificate (which may also be referred to as a certificate, a machine-checkable certificate, or an embedded proof) is a machine-checkable proof that the quantum error correction protocol satisfies the one or more properties. The term “machine-checkable” means that the proof may be verified by a computer program without human intervention, in contrast to an informal argument or empirical observation. In some implementations, the synthesizing may comprise performing an AI-assisted proof search (that is, using machine learning techniques to guide the theorem prover toward discovering a proof more efficiently than unguided search). The synthesis process may iterate through multiple candidate protocols before identifying one for which a valid proof may be constructed. The output of the synthesis process is a certified QEC protocol: a paired combination of the quantum error correction protocol itself and the formal proof certificate that accompanies it.

The certified QEC protocol is then compiled into a quantum circuit with the formal proof certificate embedded in the quantum circuit. This process is analogous to proof-carrying code in classical software verification, in which a compiled program carries a machine-checkable proof of its safety properties. In the quantum context, the quantum circuit includes the gate sequences, qubit allocations, and measurement schedules that implement the quantum error correction protocol, and the formal proof certificate is attached as metadata, annotations in the circuit's intermediate representation, or auxiliary classical data accompanying the circuit. The compiled quantum circuit is then deployed onto quantum computing hardware, where it executes to provide error correction during quantum computation.

In some implementations, the framework may further include runtime monitoring and adaptive re-synthesis. After the quantum circuit has been deployed onto quantum computing hardware, a monitoring process may obtain operational data (which may also be referred to as runtime data, monitoring data, or syndrome data) by observing the operation of the quantum computing hardware. The operational data may include error syndromes extracted from stabilizer measurements during QEC operation. Based on the operational data, a verification process may determine whether the formal proof certificate remains valid under the current operating conditions of the quantum computing hardware. In some implementations, the verifying may comprise executing a lightweight certificate verification routine on classical computing hardware coupled to the quantum computing hardware. The lightweight certificate verification routine may check the certificate quickly without re-running the full synthesis and proof process. The classical computing hardware on which the verification routine executes may include, but is not limited to, field-programmable gate arrays (FPGAs) for low-latency monitoring, conventional CPUs, or dedicated application-specific integrated circuits (ASICs). In some implementations, the verification may be performed continuously, periodically, or in response to a triggering event.

If the verification process determines that the formal proof certificate does not remain valid under the current operating conditions, the framework may trigger adaptive re-synthesis. The adaptive re-synthesis process may characterize a current noise model (that is, a mathematical description of the types and rates of errors the quantum computing hardware is currently exhibiting) based on the operational data. Noise characterization may be performed using quantum process tomography, randomized benchmarking, gate set tomography, or simplified noise proxy measurements. The framework may then re-synthesize an updated quantum error correction protocol and an updated formal proof certificate based on the current noise model, using the same formal synthesis process described above but with specifications updated to reflect the changed conditions. In some implementations, the updated quantum error correction protocol may be compiled into an updated quantum circuit with the updated formal proof certificate embedded therein, and the updated quantum circuit may be deployed onto the quantum computing hardware to replace the previously deployed quantum circuit. This adaptive process converts a static, one-time verification into a dynamic, self-maintaining system that continuously adapts to changing hardware conditions.

The computational acceleration framework addresses the sampling bottleneck by providing a systematic method for mapping computational tasks onto a probabilistic computing device. A probabilistic computing device is a hardware device that natively generates samples from a probability distribution. The term “natively generates” means that the sampling occurs as a physical process of the hardware itself, in contrast to software-based sampling in which an iterative algorithm running on a conventional processor simulates the sampling process. In some implementations, the probabilistic computing device may be implemented as a dedicated application-specific integrated circuit (ASIC), a field-programmable gate array (FPGA)-based accelerator, a neuromorphic chip, an optical system, or other specialized hardware.

The computational acceleration framework receives a computational task (which may also be referred to as a problem specification, an application instance, or a target computation). The framework determines an energy function (which may also be referred to as an energy landscape, a cost function encoding, or a Hamiltonian) that maps configurations of variables to energy values. The configurations of variables may include configurations of binary variables, though in some implementations the variables may be discrete or continuous. The energy function is designed such that it encodes a structure of the computational task as a probability distribution. The probability distribution may take the form of a distribution in which lower-energy configurations have higher probability, so that the structure of the computational task, including its solutions, optima, or statistical properties, is represented in the distribution's probability landscape. The framework configures the probabilistic computing device with parameters of the energy function. Once configured, the probabilistic computing device generates a plurality of samples from the probability distribution. A result of the computational task is then determined based on the plurality of samples.

In some implementations, the framework may further comprise training the parameters of the energy function. The parameters (which may also be referred to as tunable parameters, weights, or coupling constants) may be trained by iteratively generating samples from the probabilistic computing device and adjusting the parameters to reduce a divergence (such as a Kullback-Leibler divergence) between the probability distribution realized on the device and a target distribution associated with the computational task. The target distribution is the distribution that, if sampled perfectly, would yield the desired computational result. Training the parameters may involve gradient descent, contrastive divergence, persistent contrastive divergence, score matching, or other optimization algorithms for energy-based models.

The computational acceleration framework may be applied to a variety of computational tasks. In some implementations, the computational task may comprise a high-dimensional integration task, in which determining the result comprises computing an expectation of a function over the plurality of samples. A specific example is the pricing of financial derivatives involving multiple underlying assets. In this application, the joint distribution of asset prices is modeled as an energy-based distribution, the parameters of the energy function are trained so that the realized distribution approximates the risk-neutral pricing measure, the probabilistic computing device generates samples corresponding to asset price scenarios, the payoff function is evaluated at each sample, and the discounted average of the payoffs yields the derivative price. This approach may generalize to any high-dimensional integration task, including insurance risk aggregation, statistical physics partition function computation, and Bayesian model evidence estimation.

Many problems arising from industrial applications such as finance, insurance, aerospace, automotive, pharmaceuticals, climate science, energy, telecommunications, machine learning, data science, robotics, bioinformatics, computational chemistry, quantum physics, computer graphics may involve integration of multi-variable functions of the form

$$I = \int f ( {x}_{1} , {x}_{2} , … , {x}_{n} ) {dx}_{1} {dx}_{2} … {dx}_{n} .$$

In some implementations, randomness may be leveraged to approximate the integral as:

$$I \approx \int h ( {s}_{1} , {s}_{2} , … , {s}_{n} ) q ( {s}_{1} , {s}_{2} , … , {s}_{n} ) {ds}_{1} {ds}_{2} … {ds}_{n}$$

where the sᵢ variables are random variables sampled from probability distribution q. The integration problem is then transformed to a problem of evaluating the expectation of a multi-variate function with respect to a probability distribution q. A probabilistic computing device configured to sample from energy-based equilibrium distributions may be applied to this transformed problem. By training the parameters of the distribution such that p_{θ}(sᵢ, s₂, . . . , sₙ)∓q(s₁, s₂, . . . , sₙ) approximates the target distribution, the probabilistic computing device may provide acceleration over conventional sampling methods such as Monte Carlo calculations. In the context of derivative pricing in quantitative finance, the computational task may involve evaluating the fair price of a derivative at time t with future maturity time T by computing

$$V ( t ) = {\int }_{t}^{T} {e}^{- r ( T - t )} v ( s ) p ( {s}_{T} = s \vert {s}_{t} , t ) ds .$$

In this formulation, the risk-free rate r contributes to the discount factor e^{-r(t-τ)}, v(s) represents the payoff of the option at time T with the price of the underlying asset at s at maturity, and p(s_{T}=s|sₜ, t) represents the risk-neutral probability density for the price of the underlying asset at T.

In some implementations, for derivatives of multiple underlying assets with value s₁, s₂, . . . , sₖ the pricing problem may be formulated as

$$V ( t ) = {e}^{- r ( T - t )} 𝔼 [ v ( {s}_{1} , {s}_{2} , … , {s}_{k} ) ] .$$

In some implementations, the formulation may operate in the log-price domain. Defining xⱼ=ln sⱼ, j=1, 2, . . . , and assuming that under the risk-neutral measure, the joint probability distribution x=(x₁, x₂, . . . , xₖ) is known, the distribution may in some cases (for example, if the log returns are jointly Gaussian) be expressed in a thermal form

$$q ( {x}_{1} , {x}_{2} , … , {x}_{k} ) = \frac{1}{Z} exp [ - H ( {x}_{1} , {x}_{2} , … , {x}_{k} ) ]$$

for an energy function H. In implementations where the price dynamics sₜ are modeled as a geometric Brownian motion, the derivative price may be expressed as

$$V ( t ) = {e}^{- r ( T - t )} {\int }_{- ∞}^{∞} {\int }_{- ∞}^{∞} {dx}_{1} {dx}_{2} … {dx}_{k} v ( {e}^{{x}_{1}} , {e}^{{x}_{2}} , … {e}^{{x}_{k}} ) q ( {x}_{1} , {x}_{2} , … , {x}_{k} ) .$$

The exponential form of the probability distribution p_{θ}(x₁, x₂, . . . , xₖ) on the probabilistic computing device may be sufficiently expressive such that the parameters θ such that p_{θ}≈q. In some implementations, the value of V(t) may then be estimated by obtaining m samples x⁽¹⁾, x⁽²⁾, . . . , x^{(m)} from the probabilistic computing device, with each

$${x}^{( j )} = ( {x}_{1}^{( j )} , {x}_{2}^{( j )} , … , {x}_{k}^{( j )} )$$

and computing an average over the samples:

$$\hat{V} ( t ) = {e}^{- t ( T - t )} \cdot \frac{1}{m} {{\sum }_{j = 1}}^{m} v ( {e}^{{x}_{1}^{( j )}} , {e}^{{x}_{2}^{( j )}} , … , {e}^{{x}_{k}^{( j )}} ) .$$

The native sampling capability of the probabilistic computing device may provide acceleration over conventional Monte Carlo simulation methods for such high-dimensional integration tasks.

In some implementations, the computational task may comprise a combinatorial optimization task defined over binary variables. Examples of combinatorial optimization tasks include, but are not limited to, logistics scheduling, network design, and Multiple-Input Multiple-Output (MIMO) signal decoding in wireless communication systems. In MIMO decoding, the objective is to determine the most likely transmitted signal given noisy observations from multiple antennas, which may be formulated as a Quadratic Unconstrained Binary Optimization (QUBO) problem. The probabilistic computing device may address such problems through several approaches. In one approach, a Gibbs sampling process may be performed in which the device computes energy changes for individual variables and samples updated variable values from conditional distributions. The probabilistic computing device may update multiple variables simultaneously using a parallelized Gibbs sampling process with convergence guarantees, providing an advantage over sequential software-based Gibbs sampling. In another approach, a simulated annealing process may be performed in which the device generates candidate solutions at progressively decreasing temperatures according to a cooling schedule, with acceptance determined by a Metropolis criterion. In yet another approach, a parallel tempering process may be performed in which multiple replicas of the system operate simultaneously at different temperatures, with configurations exchanged between replicas based on an exchange probability criterion, and the final solution selected from the lowest-temperature replica. For combinatorial optimization tasks, determining the result may comprise selecting, from the plurality of samples, a sample having a minimum energy value.

In some implementations, the computational task may comprise distilling a teacher model into a student model. The teacher model (which may also be referred to as a source model, a high-capacity model, or a reference model) is a trained model, such as a large language model or a diffusion model, that produces an output distribution. The student model is the probability distribution realized on the probabilistic computing device. The parameters of the energy function are trained by minimizing a divergence between the output distribution of the teacher model and the probability distribution on the device. Once trained, the student model running on the probabilistic computing device may provide lower latency and lower power consumption than the teacher model running on conventional hardware.

In the model distillation context, the training of the student model may involve transferring knowledge from the teacher model q(x) to the energy-based student model p_{θ}(x) on the probabilistic computing device. In some implementations, the training may be performed by minimizing the Kullback-Leibler (KL) divergence between the teacher and student distributions:

$${D}_{KL} ( q ( x ) \vert {p}_{θ} ( x ) ) = \sum q ( x ) log ( \frac{q ( x )}{{p}_{θ} ( x )} ) .$$

Expanding p_{θ}(x):

$${D}_{KL} ( q ( x ) \vert {p}_{θ} ( x ) ) = \sum q ( x ) ( log q ( x ) - ( - {E}_{θ} ( x ) - log Z ) ) .$$

Ignoring constants independent of θ, this expression simplifies to:

$${D}_{KL} ( q ( x ) \vert {p}_{θ} ( x ) ) ∝ {E}_{x ∼ q} [ {E}_{θ} ( x ) + log Z ]$$

Minimizing this objective may train the energy function E_{θ}(x) of the probabilistic computing device to approximate the generative behavior of the teacher model.

In some implementations, the training procedure for model distillation may include generating samples from the teacher model, and updating the parameters to minimize an empirical KL divergence. Once the parameters have been trained, the probabilistic computing device may sample from the trained distribution using the native stochastic sampling process of the hardware. The trained student model operating on the probabilistic computing device may perform inference with lower latency and lower power consumption than the teacher model operating on conventional hardware.

In some implementations, the computational acceleration framework may further include a hybrid adaptive approach in which the probabilistic computing device operates in conjunction with a classical processor. In the hybrid adaptive approach, a classical optimization algorithm (such as simulated annealing, parallel tempering, or a genetic algorithm) is initialized on the classical processor to generate an initial set of candidate solutions for the computational task. From the initial set, a subset of high-quality solutions is identified based on a cost function (that is, solutions satisfying a quality threshold are selected). A probabilistic model is then trained on the probabilistic computing device based on the subset of high-quality solutions, such that the probability distribution on the device approximates a distribution of the high-quality solutions. The probabilistic model may be a Restricted Boltzmann Machine, a general Boltzmann machine, a Gaussian Mixture Model, or a Variational Autoencoder. The probabilistic computing device generates new candidate solutions by sampling from the trained distribution. These new candidate solutions are injected into the classical optimization algorithm executing on the classical processor to augment the search performed by the classical optimization algorithm. If a convergence criterion is not satisfied, the probabilistic model is updated based on newly discovered high-quality solutions from the augmented search, and the process of generating, injecting, and checking convergence repeats. This hybrid approach combines the broad exploration capabilities of the classical optimization algorithm with the generative capabilities of the probabilistic computing device, which may focus sampling on promising regions of the solution space that the classical algorithm alone may not reach.

The computational acceleration framework may be applied to additional computational tasks beyond those described above. In some implementations, the probabilistic computing device may be configured to sample from experimental design distributions in high-dimensional chemical and biological systems, providing accelerated drug discovery and materials science applications. In some implementations, the probabilistic computing device may be configured to approximate posterior distributions in Bayesian inference, providing efficient few-shot learning and uncertainty-aware decision-making. In some implementations, the probabilistic computing device may be configured to enhance reinforcement learning exploration strategies by sampling from energy-based models, improving efficiency in training automated agents. In some implementations, the probabilistic computing device may be embedded within probabilistic programming frameworks to accelerate probabilistic inference in applications such as statistical modeling, risk assessment, and deep learning. In some implementations, the probabilistic computing device may be configured to model energy landscapes in protein folding and molecular structure prediction. In some implementations, the probabilistic computing device may be configured to generate stable material structures in generative design applications, accelerating the discovery of novel materials and catalysts. In some implementations, the probabilistic computing device may be employed to generate cryptographically secure keys and analyze vulnerabilities in security protocols through structured high-dimensional sampling. In some implementations, the probabilistic computing device may be configured to synthesize rare-event distributions for improving the robustness of anomaly detection models in real-world transaction data.

The bidirectional characterization platform provides a computing platform (which may also be referred to as a benchmarking and resource estimation platform, a hardware characterization system, or a bidirectional analysis tool) that performs two complementary analyses on non-conventional computing devices. In a forward analysis, the platform receives an application instance defining a computational task intended for execution on a non-conventional computing device. The platform compiles the application instance into a compiled representation (which may also be referred to as an intermediate representation, a hardware-level program, or a compiled program) suitable for execution on the non-conventional computing device. The compiled representation may include specific gate sequences, qubit allocations, and connectivity requirements for quantum computing hardware, or energy function specifications for a probabilistic computing device. The compilation may target gate-model quantum circuits, quantum annealing problem graphs, measurement-based cluster states, or probabilistic computing device energy functions, depending on the target hardware modality. The platform analyzes the compiled representation to determine resource requirements, which may include qubit count, gate count, circuit depth, error budget, execution time, and classical pre-processing and post-processing requirements. From the resource requirements, the platform generates a hardware specification describing hardware capabilities needed to execute the application instance.

In an inverse analysis, the platform receives a hardware specification describing capabilities of a non-conventional computing device. In some implementations where the non-conventional computing device comprises a quantum computing device, the hardware specification may comprise at least one of a qubit count, gate fidelities, a connectivity graph, or coherence times. In some implementations, the non-conventional computing device may comprise a probabilistic computing device that natively generates samples from energy-based probability distributions. The platform maps the hardware specification to a resource envelope (which may also be referred to as a capability envelope, a resource budget, or a feasibility boundary) defining computational resource budgets supportable by the non-conventional computing device. The platform evaluates a plurality of application instances against the resource envelope to identify application instances having resource requirements within the resource envelope. In some implementations, the evaluating may comprise querying a catalog of pre-analyzed application instances (which may also be referred to as an application database, a benchmark repository, or a capability catalog), each pre-analyzed application instance having an associated resource estimate determined by a prior forward analysis. The platform outputs an indication of the identified application instances as computational tasks that the non-conventional computing device is capable of executing. In some implementations, the platform may further rank the identified application instances based on an expected performance quality on the non-conventional computing device, providing a graduated assessment rather than a binary feasible-or-infeasible determination.

The three aspects described above may operate independently or in combination. In some implementations, the bidirectional characterization platform may be used to characterize the application capabilities of a probabilistic computing device, creating a synergy between the characterization and acceleration aspects. In some implementations, the proof-carrying QEC framework may be applied to verify quantum circuits used in quantum-classical hybrid implementations of computational tasks that involve both quantum and classical processing stages.

The proof-carrying quantum error correction framework provides formal guarantees of correctness for quantum error correction protocols, in contrast to empirical validation approaches that may fail to detect errors under real hardware conditions. The framework may reduce the risk of silent computation corruption by embedding machine-checkable proofs directly into quantum circuits. In implementations that include runtime monitoring and adaptive re-synthesis, the framework may provide continuous assurance that the quantum error correction protocol remains valid under current operating conditions, and may automatically adapt when hardware noise characteristics change, converting a static verification into a self-maintaining reliability system.

The computational acceleration framework may provide acceleration of sampling-based computational tasks by leveraging a probabilistic computing device that natively generates samples from probability distributions. Because the sampling occurs as a physical process of the hardware rather than as an iterative software algorithm, the probabilistic computing device may generate samples faster and with lower energy consumption than conventional processors performing the same task in software. The hybrid adaptive approach may combine the broad exploration capabilities of classical optimization algorithms with the generative capabilities of the probabilistic computing device, potentially improving convergence rates and solution quality for combinatorial optimization problems. The framework's applicability to a variety of computational tasks, including high-dimensional integration, combinatorial optimization, and model distillation, may provide a unified approach to accelerating diverse applications using a single hardware platform.

The bidirectional characterization platform may provide a systematic approach for performing inverse analysis on non-conventional computing devices, which may assist hardware vendors, application developers, and funding entities in making quantitative assessments of which computational tasks a given device may address. The forward analysis capability may automate the resource estimation process that currently requires deep domain expertise. The combination of forward and inverse analysis in a single platform may provide comprehensive characterization of the relationship between hardware capabilities and application requirements.

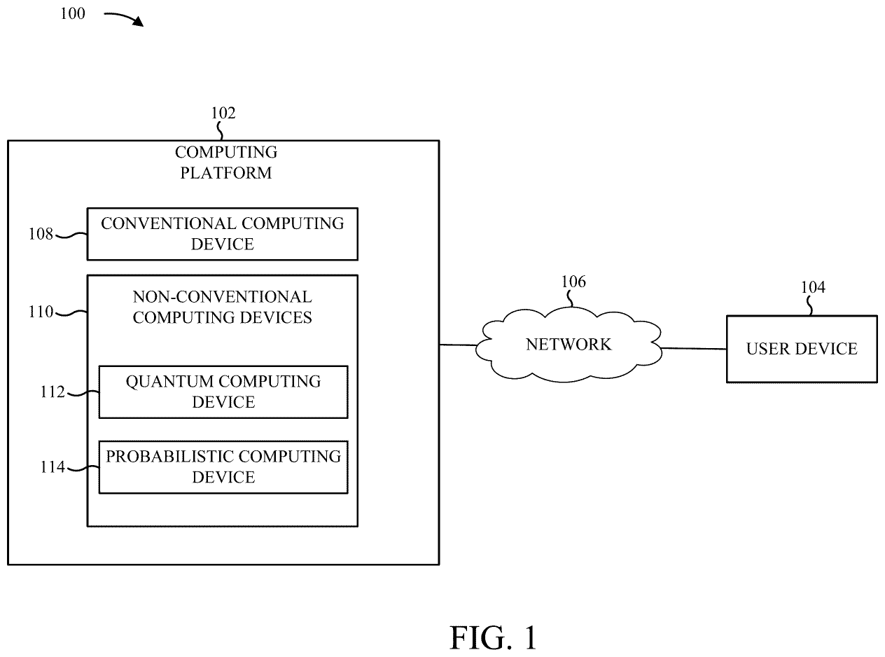

FIG. 1 is a block diagram of a computing environment, in accordance with certain embodiments of the present disclosure. As shown in FIG. 1, a computing environment 100 includes a computing platform 102, a user device 104, a network 106, a conventional computing device 108, and non-conventional computing devices 110. The non-conventional computing devices 110 include a quantum computing device 112 and a probabilistic computing device 114.

The computing environment 100 (which may also be referred to as a computing system, a distributed computing architecture, or a computational infrastructure) represents the overall system within which the operations described herein may be performed. The computing environment 100 may encompass hardware components, software components, and communication pathways that collectively support the benchmarking, resource estimation, formal verification, and computational task orchestration described throughout this disclosure. In some implementations, the computing environment 100 may be deployed within a single data center. In some implementations, the computing environment 100 may span multiple geographic locations connected via wide-area communication links.

The computing platform 102 (which may also be referred to as a benchmarking and resource estimation platform, a computational orchestration system, or a hardware characterization platform) may be a computing system comprising one or more processors and one or more memories storing instructions that, when executed by the one or more processors, cause the computing platform 102 to perform the operations described herein. The computing platform 102 may be configured to host the benchmarking and resource estimation operations, the formal verification operations, and the computational task orchestration operations described throughout this disclosure. The computing platform 102 may receive application instances from the user device 104 and may compile, analyze, and execute those application instances on appropriate computing hardware within the computing environment 100. The computing platform 102 may be communicatively coupled to both the conventional computing device 108 and the non-conventional computing devices 110 via the network 106 or via direct communication links, and may orchestrate the allocation and execution of computational tasks across those devices.

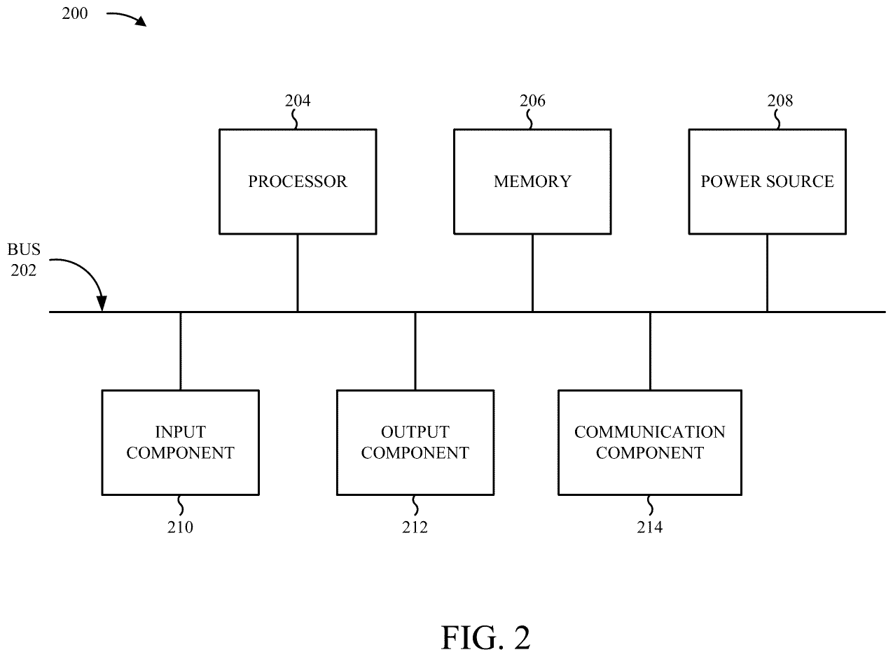

In some implementations, the computing platform 102 may be implemented as a cloud-based platform hosted on one or more remote servers accessible via the network 106. In some implementations, the computing platform 102 may be implemented as an on-premises server or cluster of servers within a data center. In some implementations, the computing platform 102 may be implemented as a distributed computing system in which components of the computing platform 102 are distributed across multiple physical or virtual machines. The computing platform 102 may include one or more application programming interfaces (APIs) through which external systems, including the user device 104, may submit requests, retrieve results, and access characterization data. The computing platform 102 may be, be similar to, include, or be included in one or more computing devices such as the computing device 200 shown in FIG. 2.

The computing platform 102 may be configured to perform both forward analysis and inverse analysis on non-conventional computing devices. In the forward analysis, the computing platform 102 may receive an application instance defining a computational task, compile the application instance into a compiled representation suitable for execution on a non-conventional computing device, analyze the compiled representation to determine resource requirements, and generate a hardware specification describing hardware capabilities needed to execute the application instance. In the inverse analysis, the computing platform 102 may receive a hardware specification describing capabilities of a non-conventional computing device, map the hardware specification to a resource envelope defining computational resource budgets supportable by the non-conventional computing device, evaluate a plurality of application instances against the resource envelope to identify application instances having resource requirements within the resource envelope, and output an indication of the identified application instances as computational tasks that the non-conventional computing device is capable of executing. The computing platform 102 may further be configured to synthesize quantum error correction protocols with embedded formal proof certificates, compile those protocols into quantum circuits, and deploy the quantum circuits onto quantum computing hardware.

The user device 104 (which may also be referred to as a client device, an end-user terminal, or a user computing device) may be a computing device through which a user interacts with the computing platform 102 to submit computational tasks, provide hardware specifications, and receive analysis results. Examples of the user device 104 include, but are not limited to, desktop computers, laptop computers, tablet computers, smartphones, workstations, and thin-client terminals. The user device 104 may include a client application providing a graphical user interface (GUI) through which the user may define application instances, specify hardware parameters, review resource estimation results, and initiate computational tasks on the non-conventional computing devices 110.

In some implementations, the user device 104 may communicate with the computing platform 102 via the network 106 using one or more communication protocols. In some implementations, the user device 104 may include a web browser configured to access a web-based interface provided by the computing platform 102. In some implementations, the user device 104 may include a command-line interface or an API client configured to submit requests programmatically to the computing platform 102. The user device 104 may be, be similar to, include, or be included in one or more computing devices such as the computing device 200 shown in FIG. 2.

The network 106 (which may also be referred to as a communication network, a data network, or a network infrastructure) may be a communication medium that communicatively couples the computing platform 102, the user device 104, the conventional computing device 108, and the non-conventional computing devices 110. Examples of the network 106 include, but are not limited to, a local area network (LAN), a wide area network (WAN), the Internet, a cellular network, a satellite network, or any combination thereof. In some implementations, the network 106 may include wired communication links, wireless communication links, or a combination of wired and wireless communication links. The network 106 may support data transmission using one or more communication protocols including, but not limited to, Hypertext Transfer Protocol (HTTP), Transmission Control Protocol/Internet Protocol (TCP/IP), WebSocket, or Message Queuing Telemetry Transport (MQTT).

The conventional computing device 108 (which may also be referred to as a classical computing device, a general-purpose computing device, or a standard processor-based computing device) may be computing hardware based on conventional processor architectures including central processing units (CPUs) and graphics processing units (GPUs). The conventional computing device 108 may execute deterministic instructions using transistor-based logic circuits that switch between binary states. The computing platform 102 may include or may be communicatively coupled to the conventional computing device 108, and the conventional computing device 108 may serve as a baseline against which the performance of the non-conventional computing devices 110 is benchmarked or compared. In some implementations, the conventional computing device 108 may perform classical pre-processing and post-processing operations in conjunction with computational tasks executed on the non-conventional computing devices 110.

In some implementations, the conventional computing device 108 may include one or more multi-core CPUs, one or more GPUs, or a combination thereof. In some implementations, the conventional computing device 108 may include field-programmable gate arrays (FPGAs) or digital signal processors (DSPs) that supplement the CPUs and GPUs. The conventional computing device 108 may be, be similar to, include, or be included in one or more computing devices such as the computing device 200 shown in FIG. 2. For example, the conventional computing device 108 may be hosted within a cloud computing environment as one or more virtual machine instances or container-based services.

The non-conventional computing devices 110 (which may also be referred to as specialized computing devices, alternative-architecture computing devices, or non-standard computing hardware) may be computing hardware that differs from conventional processors, including CPUs and GPUs, in its fundamental approach to computation. The non-conventional computing devices 110 encompass hardware architectures that leverage different physical processes from those used by CPUs and GPUs, as well as classical devices built for specialized mathematical operations that conventional processors perform inefficiently. The non-conventional computing devices 110 may be communicatively coupled to the computing platform 102 via the network 106 or via direct communication links, and the computing platform 102 may orchestrate the execution of computational tasks on the non-conventional computing devices 110.

In some implementations, the non-conventional computing devices 110 may include, in addition to the quantum computing device 112 and the probabilistic computing device 114, other specialized hardware architectures such as neuromorphic computing devices, optical computing devices, analog computing devices, or other application-specific computing architectures. In some implementations, two or more non-conventional computing devices 110 may be co-located within a single facility. In some implementations, the non-conventional computing devices 110 may be geographically distributed and accessible to the computing platform 102 via the network 106. The computing platform 102 may maintain a registry of the non-conventional computing devices 110 and their respective capabilities, and may select an appropriate non-conventional computing device for a given computational task based on the resource requirements of that task and the capabilities of the available devices.

As shown in FIG. 1, the non-conventional computing devices 110 include the quantum computing device 112 and the probabilistic computing device 114. In some implementations, the non-conventional computing devices 110 may include additional instances of the quantum computing device 112 or the probabilistic computing device 114. In some implementations, one or more of the non-conventional computing devices 110 may be implemented using any number of computing devices such as the computing device 200 shown in FIG. 2, to the extent that the non-conventional computing devices 110 include classical processing elements for control, calibration, or data handling. For example, one or more of the quantum computing device 112 and the probabilistic computing device 114 may include classical co-processors that manage device configuration, data input, and result extraction, and those classical co-processors may be distributed among a number of computing devices.

The quantum computing device 112 (which may also be referred to as a quantum computer, a quantum processor, or quantum computing hardware) may be a computing device that exploits quantum mechanical phenomena, including superposition, entanglement, and interference, to process information in ways that have no classical analogue. The quantum computing device 112 may be one type of non-conventional computing device within the non-conventional computing devices 110. The quantum computing device 112 may be characterized by a hardware specification comprising at least one of a qubit count, gate fidelities, a connectivity graph, or coherence times. The computing platform 102 may deploy quantum circuits onto the quantum computing device 112, including quantum circuits that implement quantum error correction protocols with embedded formal proof certificates.

In some implementations, the quantum computing device 112 may be implemented using a gate-model quantum computing architecture in which quantum computations are expressed as sequences of quantum gates applied to qubits. In some implementations, the quantum computing device 112 may be implemented using a quantum annealing architecture in which computations are performed by evolving a physical system toward a ground state that encodes the solution to an optimization problem. In some implementations, the quantum computing device 112 may be implemented using a measurement-based quantum computing architecture in which computations are driven by sequences of adaptive measurements on an entangled resource state. Physical implementations of the quantum computing device 112 include, but are not limited to, superconducting qubit systems, trapped ion systems, photonic systems, and topological qubit systems. The quantum computing device 112 may be, be similar to, include, or be included in the quantum computing hardware referenced throughout this disclosure.

In some implementations, the quantum computing device 112 may include classical control electronics that manage qubit initialization, gate execution, measurement readout, and error correction decoding. The classical control electronics may be communicatively coupled to the computing platform 102 and may receive compiled quantum circuits from the computing platform 102 for execution on the quantum computing device 112. The computing platform 102 may monitor operation of the quantum computing device 112 to obtain operational data, and may verify, based on the operational data, whether a formal proof certificate associated with a deployed quantum error correction protocol remains valid under current operating conditions of the quantum computing device 112.

The probabilistic computing device 114 (which may also be referred to as a probabilistic computing chip, a special-purpose classical sampling device, or a probabilistic hardware accelerator) may be a special-purpose classical hardware device whose physical architecture natively generates samples from energy-based probability distributions. The probabilistic computing device 114 is not a quantum device. Rather, the probabilistic computing device 114 is a dedicated classical device engineered so that the physical behavior of the hardware corresponds to sampling from a probability distribution of the Boltzmann form

$${p}_{θ} ( x ) = \frac{1}{Z} {e}^{- {E}_{θ} ( x )}$$

where θ represents a set of tunable parameters, x represents a configuration of variables in the sampling domain, E_{θ} represents an energy function that maps configurations of variables to energy values, and Z=∫e^{-E}^{_{θ}}^{(x)}dx represents a normalization factor. The probabilistic computing device 114 comprises hardware that natively generates samples from the probability distribution, meaning that the sampling process is carried out by the physical dynamics of the hardware rather than by iterative software algorithms executed on a general-purpose processor.

The probabilistic computing device 114 may be configured to perform several functions that collectively support the computational acceleration operations described herein. These functions include hardware-accelerated energy evaluation, in which the probabilistic computing device 114 computes energy values for candidate configurations using dedicated hardware circuits rather than software routines; parallelized variable updates with convergence guarantees, in which multiple variables in a configuration are updated simultaneously while maintaining mathematical guarantees on the convergence of the sampling process; adaptive energy landscape learning, in which the tunable parameters of the energy function are adjusted based on observed samples to reshape the probability distribution toward a target distribution associated with a computational task; and low-latency feedback, in which samples generated by the probabilistic computing device 114 are made available to coupled classical processors with minimal delay for post-processing and iterative refinement.

In some implementations, the probabilistic computing device 114 may be implemented as an application-specific integrated circuit (ASIC) designed for energy-based sampling operations. In some implementations, the probabilistic computing device 114 may be implemented using a field-programmable gate array (FPGA) configured to perform sampling from Boltzmann distributions. In some implementations, the probabilistic computing device 114 may be implemented using a neuromorphic chip architecture in which the network dynamics correspond to sampling from energy-based distributions. In some implementations, the probabilistic computing device 114 may be implemented using an optical computing system in which photonic components perform the sampling operations. The probabilistic computing device 114 may be coupled to a classical processor that configures the probabilistic computing device 114 with the parameters of the energy function, receives the generated samples, and determines a result of the computational task based on the plurality of samples. The probabilistic computing device 114 may be, be similar to, include, or be included in the non-conventional computing devices 110 described above.

In some implementations, two or more of the computing platform 102, the user device 104, the conventional computing device 108, and the non-conventional computing devices 110 may be integrated into a single component. In some implementations, one or more of the computing platform 102, the user device 104, the conventional computing device 108, and the non-conventional computing devices 110 may be implemented using any number of computing devices such as the computing device 200 shown in FIG. 2. For example, one or more of the computing platform 102, the user device 104, the conventional computing device 108, and the non-conventional computing devices 110 may be distributed among a number of computing devices connected via the network 106 or via dedicated communication links.

FIG. 2 is a block diagram of a computing device, in accordance with certain embodiments of the present disclosure. FIG. 2 shows a block diagram of an example of a computing device 200 capable of performing functions described herein. The computing device 200 may be used to implement one or more components of the computing environment 100. The computing device 200 may correspond to the computing platform 102 described above with reference to FIG. 1, the user device 104 (FIG. 1), the conventional computing device 108 (FIG. 1), or portions of the non-conventional computing devices 110 (FIG. 1) that include classical processing elements for control, calibration, or data handling. In some implementations, the computing device 200 may represent a classical co-processor coupled to the quantum computing device 112 (FIG. 1) or coupled to the probabilistic computing device 114 (FIG. 1), where the classical co-processor manages device configuration, circuit deployment, data input, and result extraction for the respective non-conventional computing device. The computing device 200 may be, be similar to, include, or be included in an apparatus for performing one or more methods, processes, algorithms, operations, tasks, and/or techniques, as described herein. The computing device 200 may be, be similar to, include, or be included in a computing device, a laptop, a workstation, a server device, or a personal computer, among other examples. The computing device 200 includes a bus 202 that interconnects various components or units, such as a processor 204, a memory 206, a power source 208, an input component 210, an output component 212, and a communication component 214, among other examples.

The processor 204 may be a central processing unit, such as a microprocessor, and may include single or multiple processors having single or multiple processing cores. The processor 204 may include another type of device, or multiple devices, configured for manipulating or processing information. In some implementations, the processor 204 may include one or more processors (which may be referred to herein as a “processor set”) capable of being programmed to perform a function. For example, the processor 204 may include multiple processors interconnected in one or more manners, including hardwired or networked. The operations of the processor 204 may be distributed across multiple devices or units that may be coupled directly or across a local area or other suitable type of network. The processor 204 may include a cache, or cache memory, for local storage of operating data or instructions. The processor 204 may be implemented in hardware, firmware, or a combination of hardware and software.

The processor 204 may include one or more chiplets, chips, system-on-chips (SoCs), network-on-chips (NoCs), chipsets, packages, or devices that individually or collectively constitute or include the processor set. The processor set may include a processor (or “processing”) circuitry in the form of one or multiple processors, microprocessors, processing units (such as CPUs), GPUs, neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor set”).

One or more of the processors of the processor set (e.g., the processor 204) may be individually or collectively configurable or configured to perform various operations described herein. In some implementations, a single processor may perform all of the operations described as being performed by the one or more processors. In some implementations, a group of processors collectively configurable or configured to perform a set of operations may include a first set of (one or more) processors configurable or configured to perform a first operation of the set and a second processor configurable or configured to perform a second operation of the set, or may include the group of processors all being configured or configurable to perform the set of operations. The first set of processors and the second set of processors may be the same set of processors or may be different sets of processors.

The memory 206 includes one or more memory components, which may each be volatile memory or non-volatile memory, that individually or collectively constitute a memory system. The memory system may include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory,” “the memory system,” or “the memory circuitry”). The memory 206 may include non-transitory memory, transitory memory, or a combination thereof. Volatile memory may include RAM (e.g., a dynamic RAM (DRAM) module, such as a double data rate (DDR) synchronous DRAM (SDRAM)). Non-volatile memory may include a disk drive, a solid state drive, flash memory, or phase-change memory. In some implementations, the memory 206 may be distributed across multiple devices. For example, the memory 206 may include network-based memory or memory in multiple clients or servers performing the operations of those multiple devices.

The memory 206 may be referred to as a computer-readable medium. A computer-readable medium may include any storage unit (or multiple storage units) that store data or instructions that are readable by a processor (e.g., the processor 204). A computer-readable medium may include, for example, at least one of a data repository, a data storage unit, a computer memory, a hard drive, a disk, or a random access memory. As used herein, the term “computer-readable medium” encompasses one or more computer readable media. A computer-readable medium may be a transitory computer-readable medium or a non-transitory computer-readable medium. In some implementations, the memory 206 may comprise a non-transitory computer-readable medium storing instructions that, when executed by the processor 204, cause the processor 204 to perform the operations described herein. Accordingly, the computing device 200 may include a processor 204 and a memory 206 storing instructions that, when executed by the processor 204, cause the computing device 200 to perform operations as described throughout this disclosure.

One or more of the memories may be coupled (for example, operatively coupled, communicatively coupled, electronically coupled, or electrically coupled) with one or more of the processors and may individually or collectively store processor-executable instructions (e.g., code such as software) that, when executed by one or more of the processors, may configure or otherwise cause one or more of the processors to perform various functions or operations described herein. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise.

In some implementations, the executable instructions may include application data or an operating system, among other examples. The executable instructions may include one or more application programs, which may be loaded or copied, in whole or in part, from non-volatile memory to volatile memory to be executed by the processor 204. For example, the executable instructions may include instructions for performing techniques described in this disclosure. In some implementations, the application data may include functional programs, such as computational programs, analytical programs, or database programs, among other examples. The operating system may be, for example, Microsoft Windows®, Mac OS X®, or Linux®; an operating system for a mobile device, such as a smartphone or tablet device; or an operating system for a non-mobile device, such as a mainframe computer.

Reference to “one or more memories” should be understood to refer to any one or more memories of a corresponding device, such as the memory described in connection with FIG. 2. For example, operation described as being performed by, or data described as being stored on, one or more memories may be performed by, or stored on, respectively, the same subset of the one or more memories or different subsets of the one or more memories. Additionally or alternatively, in some examples, one or more of the processors may be preconfigured to perform various functions or operations described herein without requiring configuration by software. For example, the memory 206 may include data or instructions that are hard-wired into the processing system.

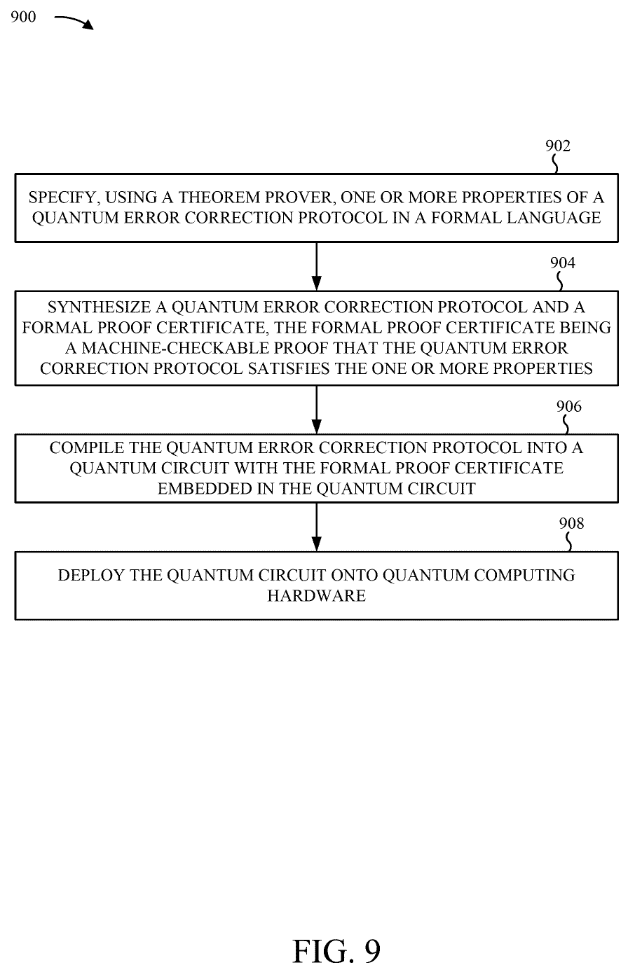

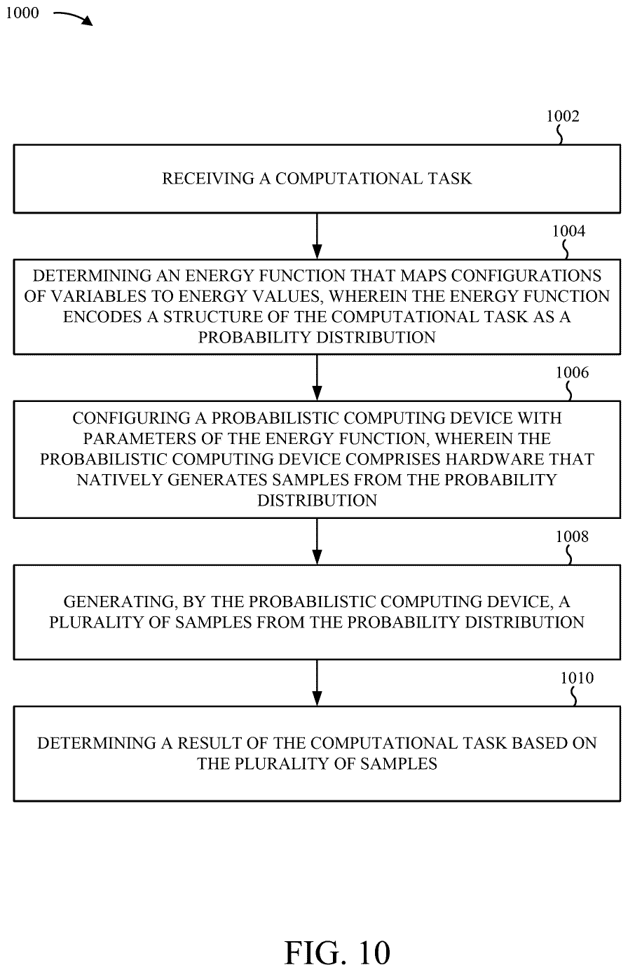

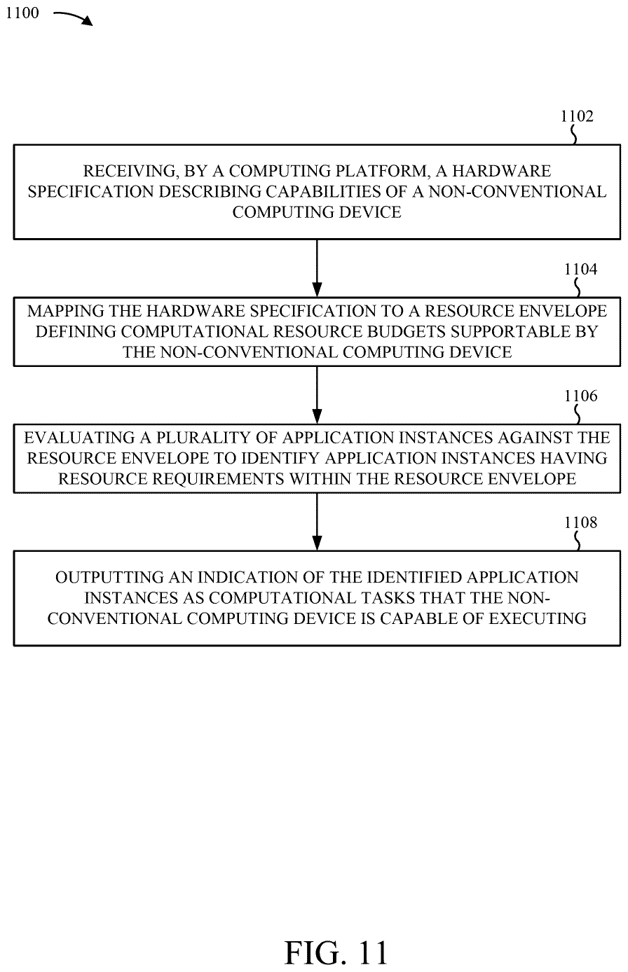

In some implementations, the processor 204 may implement one or more techniques or perform one or more operations associated with non-conventional computing, as described in more detail elsewhere herein. For example, the processor 204 may perform or direct operations of, for example, technique 900 of FIG. 9, technique 1000 of FIG. 10, technique 1100 of FIG. 11, or other techniques as described herein (alone or in conjunction with one or more other processors). In some examples, the memory 206 may include a non-transitory computer-readable medium storing a set of instructions (for example, code or program code). The set of instructions, when executed (for example, directly, or after compiling, converting, or interpreting) by the processor 204, may cause the processor 204 to cause the computing device 200 to perform technique 900 of FIG. 9, technique 1000 of FIG. 10, technique 1100 of FIG. 11, or other techniques as described herein. In some examples, executing instructions may include running the instructions, converting the instructions, compiling the instructions, and/or interpreting the instructions, among other examples.

In some implementations, the processor 204 of the computing device 200 may be coupled to the probabilistic computing device 114 (FIG. 1), and the memory 206 may store instructions that, when executed by the processor 204, cause the processor 204 to configure the probabilistic computing device 114 with parameters of an energy function, cause the probabilistic computing device 114 to generate samples from a probability distribution, and determine a result of a computational task based on the generated samples. In some implementations, the processor 204 of the computing device 200 may be coupled to the quantum computing device 112 (FIG. 1), and the memory 206 may store instructions that, when executed by the processor 204, cause the processor 204 to compile quantum error correction protocols into quantum circuits, deploy the quantum circuits onto the quantum computing device 112, and monitor operation of the quantum computing device 112 to verify that formal proof certificates remain valid under current operating conditions.

In the description herein, language describing a system, an apparatus, or a device as taking an action (such as performing, determining, initiating, receiving, calculating, deciding, computing, processing, etc.) is to be understood as describing that some appropriate component of the system, apparatus, or device is taking the action. As used herein, the term “component” is intended to be broadly construed as hardware and/or a combination of hardware and software.

An “engine” refers to a component constructed, programmed, configured, or otherwise adapted to perform a specific function or set of functions. The term engine as used herein means a tangible device, component, or arrangement of components implemented using hardware, such as by an ASIC or field-programmable gate array (FPGA), for example, or as a combination of hardware and software, such as by a processor-based computing platform and a set of program instructions that transform the computing platform into a special-purpose device to implement the specified functionality. An engine may also be implemented as a combination of the two, with some functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a given engine at one instance of time and to constitute a different engine at a different instance of time.

In some implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any single implementation exemplified herein, unless such limitations are expressly called out. As used herein, the term “model” encompasses its plain and ordinary meaning. A model may include, among other things, one or more engines which receive an input and compute an output based on the input.

The power source 208 provides power to the computing device 200. For example, the power source 208 may be an interface to an external power distribution system. In an example, the power source 208 may be a battery, such as where the computing device 200 is a mobile device or is otherwise configured to operate independently of an external power distribution system. In some implementations, the computing device 200 may include or otherwise use multiple power sources. In some such implementations, the power source 208 may be a backup battery.

The input component 210 and/or the output component 212 may include one or more input interfaces and/or output interfaces configured for facilitating communication between the computing device 200 and one or more peripheral devices such as, for example, one or more sensors, detectors, displays, input devices, or other devices configured for facilitating interaction with the computing device 200 or the environment around the computing device 200. An input device may, for example, include a positional input device, such as a mouse, touchpad, touchscreen, or the like; a keyboard; or another suitable human or machine interface device. An output device may, for example, include a display, such as a liquid crystal display, a cathode-ray tube, a light emitting diode display, or other suitable display. In some implementations, the peripherals devices may include a geolocation component, such as a global positioning system (GPS) location unit. In some examples, the peripheral devices may include a temperature sensor for measuring temperatures of components of the computing device 200, such as the processor 204.

The communication component 214 may include an interface for facilitating a connection or link to a network, including the network 106 described above with reference to FIG. 1. The communication component 214 may include a wired network interface or a wireless network interface. The computing device 200 may communicate with other devices via the communication component 214 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, a cellular communication protocol, another protocol, or a combination thereof. For example, the computing device 200 may communicate with a database server.

The communication component 214 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some implementations in conjunction with processor-readable code stored in the memory, to perform aspects of the methods, processes, techniques, and/or operations described herein.

The number and arrangement of components shown in FIG. 2 are provided as an example. The computing device 200 may include additional components, fewer components, different components, or differently arranged components than those shown in FIG. 2. Additionally, or alternatively, a set of components (e.g., one or more components) of the computing device 200 may perform one or more functions described as being performed by another set of components of the computing device 200.

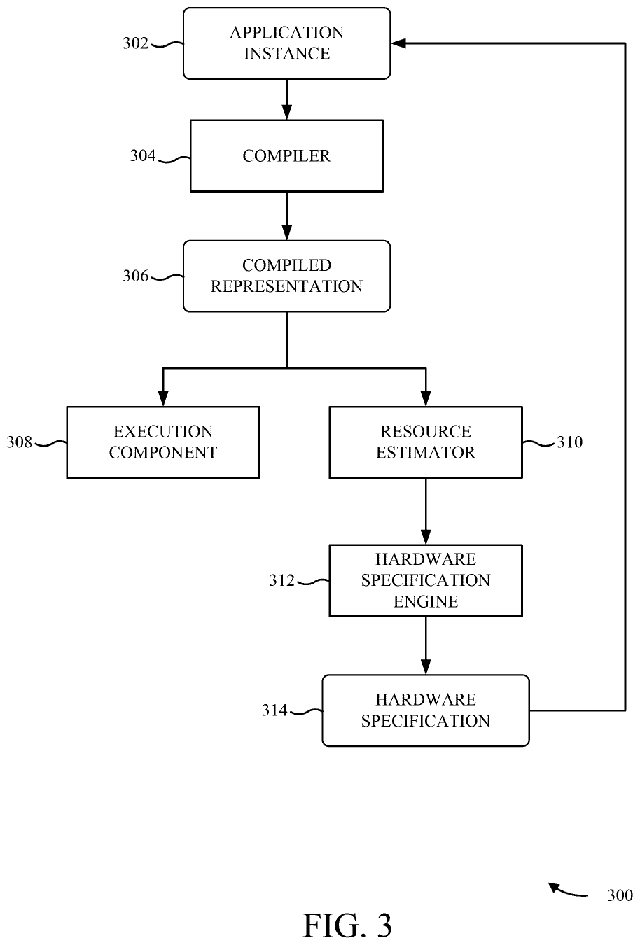

FIG. 3 is a data flow diagram of a benchmarking and resource estimation platform, in accordance with certain embodiments of the present disclosure. The data flow diagram 300 may represent operations performed by the computing platform 102, described above with reference to FIG. 1. As shown in FIG. 3, the data flow diagram 300 depicts a pipeline in which an application instance 302 is provided to a compiler 304, which produces a compiled representation 306. The compiled representation 306 is provided to an execution component 308 and to a resource estimator 310. The resource estimator 310 provides output to a hardware specification engine 312, which produces a hardware specification 314. A data flow path from the hardware specification 314 back to the application instance 302 represents an inverse analysis operation, as described in greater detail below.

The application instance 302 (which may also be referred to as a computational task definition, a problem specification, or an application program) may be a specific computational task intended for execution on a non-conventional computing device. The application instance 302 serves as the entry point to the forward analysis path depicted in the data flow diagram 300. Examples of the application instance 302 include, but are not limited to, a quantum algorithm (such as a variational quantum eigensolver, a quantum approximate optimization algorithm, or a quantum Fourier transform), a combinatorial optimization problem (such as a maximum satisfiability problem, a traveling salesman problem, or a graph partitioning problem), a sampling task (such as generating samples from a high-dimensional Boltzmann distribution), or a machine learning inference task (such as evaluating a probabilistic model or performing Bayesian posterior estimation). The application instance 302 may define the problem structure, input data, accuracy requirements, and target hardware modality for the computational task.

In some implementations, the application instance 302 may be stored in a catalog of pre-analyzed application instances (which may also be referred to as an application database, a benchmark repository, or a capability catalog). Each pre-analyzed application instance in the catalog may have an associated resource estimate determined by a prior forward analysis through the data flow diagram 300. The catalog may accumulate resource estimates over time as additional application instances are analyzed, thereby building a database of characterized computational tasks and their associated hardware requirements. In some implementations, the application instance 302 may be received from the user device 104 (FIG. 1) via a graphical user interface, a command-line interface, or an application programming interface (API) exposed by the computing platform 102 (FIG. 1).

The compiler 304 (which may also be referred to as a compilation engine, a program translator, or a hardware-targeted compiler) may be configured to receive the application instance 302 and translate the application instance 302 into a lower-level compiled representation 306 suitable for execution on a non-conventional computing device. The compiler 304 maps high-level algorithmic descriptions provided by the application instance 302 into hardware-specific instruction sequences or configurations that the target non-conventional computing device may execute. In some implementations, the compiler 304 may target gate-model quantum circuits, in which the compiled output includes sequences of quantum gate operations, qubit allocations, and connectivity mappings. In some implementations, the compiler 304 may target quantum annealing problem graphs, in which the compiled output includes an Ising model or quadratic unconstrained binary optimization (QUBO) formulation with coupling strengths mapped to the annealing hardware topology. In some implementations, the compiler 304 may target measurement-based cluster states, in which the compiled output includes an entangled resource state specification and a sequence of adaptive single-qubit measurements. In some implementations, the compiler 304 may target probabilistic computing device energy functions, in which the compiled output includes tunable parameters for an energy-based probability distribution configured on a probabilistic computing device such as the probabilistic computing device 114 (FIG. 1).

In some implementations, the compiler 304 may perform multiple optimization passes during compilation. Examples of optimization passes include, but are not limited to, circuit depth minimization (reducing the number of sequential gate layers to decrease susceptibility to decoherence), qubit count minimization (reducing the number of physical qubits through efficient qubit reuse or mapping strategies), error rate minimization (selecting gate decompositions and routing paths that reduce the cumulative error probability), and connectivity-aware routing (mapping logical qubits to physical qubits in a manner that respects the topology of the target hardware). In some implementations, the compiler 304 may apply different optimization strategies depending on the target hardware modality, such that a compilation targeting a superconducting qubit device may apply different routing heuristics than a compilation targeting a trapped ion device.

The compiled representation 306 (which may also be referred to as an intermediate representation, a hardware-level program, or a compiled program) may be the intermediate form of the application instance 302 after compilation by the compiler 304. The compiled representation 306 represents the application instance 302 in a form that is optimized for both analysis and execution on a target non-conventional computing device. As shown in FIG. 3, the compiled representation 306 feeds two parallel paths: a first path to the execution component 308, and a second path to the resource estimator 310. The compiled representation 306 may include specific gate sequences, qubit allocations, and connectivity requirements for quantum computing hardware, or energy function specifications and parameter configurations for a probabilistic computing device.

The execution component 308 (which may also be referred to as a validation engine, a simulation component, or a runtime executor) may be configured to receive the compiled representation 306 and run the compiled representation 306 on a processor, a simulator, or a target hardware device to validate the correctness of the compilation. The execution component 308 may verify that the compiled representation 306 produces expected outputs for known input cases, thereby confirming that the compilation performed by the compiler 304 faithfully preserves the semantics of the original application instance 302. In some implementations, the execution component 308 may execute the compiled representation 306 on a software simulator that models the behavior of the target non-conventional computing device without consuming physical hardware resources. In some implementations, the execution component 308 may execute the compiled representation 306 on the target non-conventional computing device itself, using small-scale test inputs. In some implementations, the execution by the execution component 308 may be an optional step that is performed selectively based on whether validation is requested for a given application instance 302.

The resource estimator 310 (which may also be referred to as a resource analysis engine, a cost estimator, or a computational resource analyzer) may be configured to receive the compiled representation 306 and evaluate the compiled representation 306 to determine resource requirements and performance characteristics for executing the application instance 302 on a target non-conventional computing device. The resource estimator 310 may analyze the compiled representation 306 to determine resource requirements that include, but are not limited to, qubit count (the number of physical qubits consumed by the compiled circuit), gate count (the total number of quantum gate operations), circuit depth (the number of sequential time steps in the circuit), error budget (the maximum cumulative error probability tolerable for the computation to produce a meaningful result), execution time (the wall-clock time for executing the compiled representation on the target hardware), and classical pre-processing and post-processing requirements (the computational resources consumed by classical operations that accompany the non-conventional computation).

In some implementations, the resource estimator 310 may determine the resource requirements using analytical models that compute resource counts directly from structural properties of the compiled representation 306, such as gate counts, qubit connectivity graphs, and circuit depth metrics. In some implementations, the resource estimator 310 may determine the resource requirements using simulation-based estimation, in which the compiled representation 306 is executed on a classical simulator to observe resource consumption under realistic conditions. In some implementations, the resource estimator 310 may determine the resource requirements using machine learning surrogate models, in which a trained model predicts resource consumption based on features extracted from the compiled representation 306 without performing full simulation. The resource estimator 310 provides the determined resource requirements to the hardware specification engine 312 for further processing.

The hardware specification engine 312 (which may also be referred to as a hardware characterization engine, a specification generator, or a bidirectional analysis engine) may be configured to operate in two complementary modes: a forward analysis mode and an inverse analysis mode.

In the forward analysis mode, the hardware specification engine 312 receives the resource requirements from the resource estimator 310 and derives hardware-specific requirements and configurations from those resource requirements. The hardware specification engine 312 generates a hardware specification 314 describing hardware capabilities needed to execute the application instance 302. The forward analysis performed by the hardware specification engine 312 answers the question: for a given application instance 302, what hardware capabilities are needed to execute the application instance 302 on a non-conventional computing device? In some implementations, the forward analysis mode may include receiving the application instance 302 defining a computational task, compiling the application instance 302 into the compiled representation 306 suitable for execution on the non-conventional computing device (via the compiler 304), analyzing the compiled representation 306 to determine resource requirements (via the resource estimator 310), and generating the hardware specification 314 describing hardware capabilities needed to execute the application instance 302. The forward analysis mode thus encompasses the path from the application instance 302 through the compiler 304, the compiled representation 306, the resource estimator 310, the hardware specification engine 312, and the hardware specification 314.

In the inverse analysis mode, the hardware specification engine 312 receives a hardware specification 314 describing capabilities of a non-conventional computing device. The hardware specification engine 312 maps the hardware specification 314 to a resource envelope (which may also be referred to as a capability envelope, a resource budget, or a feasibility boundary) defining computational resource budgets supportable by the non-conventional computing device. The resource envelope represents the set of resource constraints (such as maximum qubit count, maximum circuit depth, minimum gate fidelity, and available coherence time) within which a computational task may be feasibly executed on the described hardware. The hardware specification engine 312 evaluates a plurality of application instances against the resource envelope to identify application instances having resource requirements within the resource envelope. In some implementations, the evaluating may include querying a catalog of pre-analyzed application instances, each pre-analyzed application instance having an associated resource estimate determined by a prior forward analysis through the data flow diagram 300. The hardware specification engine 312 outputs an indication of the identified application instances as computational tasks that the non-conventional computing device is capable of executing. The inverse analysis performed by the hardware specification engine 312 answers the question: for a given non-conventional computing device with known capabilities, what computational tasks may that device execute? The data flow path from the hardware specification 314 back to the application instance 302 shown in FIG. 3 represents this inverse analysis mode, in which the output is one or more identified application instances 302 that fall within the resource envelope of the described hardware.

In some implementations, the hardware specification engine 312 may further rank the identified application instances based on an expected performance quality on the non-conventional computing device, providing a graduated assessment that orders the identified application instances according to how well-suited each application instance is for the described hardware, rather than providing a binary feasible-or-infeasible determination. The ranking may take into account factors such as the ratio of available resources to consumed resources, the expected error rate of the computation, and the estimated execution time relative to a usefulness threshold.

The hardware specification 314 (which may also be referred to as a hardware capability description, a device specification, or a hardware profile) may be a data structure that describes the capabilities of a non-conventional computing device in terms of quantitative resource parameters. In the context of the forward analysis mode, the hardware specification 314 represents the output of the analysis pipeline and describes the hardware capabilities needed to execute a given application instance 302. In the context of the inverse analysis mode, the hardware specification 314 represents the input to the analysis and describes the capabilities of a given hardware device. In some implementations, the non-conventional computing device described by the hardware specification 314 may include a quantum computing device, and the hardware specification 314 may include at least one of a qubit count, gate fidelities, a connectivity graph, or coherence times. The hardware specification 314 may further include measurement speeds, classical control bandwidth, error correction overhead, and available calibration data.

In some implementations, the non-conventional computing device described by the hardware specification 314 may include a probabilistic computing device that natively generates samples from energy-based probability distributions, and the hardware specification 314 may include parameters such as the number of binary variables supported, the connectivity topology among variables, the sampling rate, the achievable temperature range, and the precision of tunable energy function parameters. The hardware specification 314 may describe capabilities of the non-conventional computing devices 110 (FIG. 1), including the quantum computing device 112 or the probabilistic computing device 114. The hardware specification 314 may be received from a hardware vendor, generated from empirical characterization of a physical device, or constructed from published device specifications.

In some implementations, two or more of the compiler 304, the execution component 308, the resource estimator 310, and the hardware specification engine 312 may be integrated into a single component. In some implementations, one or more of the compiler 304, the execution component 308, the resource estimator 310, and the hardware specification engine 312 may be implemented using any number of computing devices such as the computing device 200 shown in FIG. 2. For example, one or more of the compiler 304, the execution component 308, the resource estimator 310, and the hardware specification engine 312 may be distributed among a number of computing devices connected via the network 106 (FIG. 1).

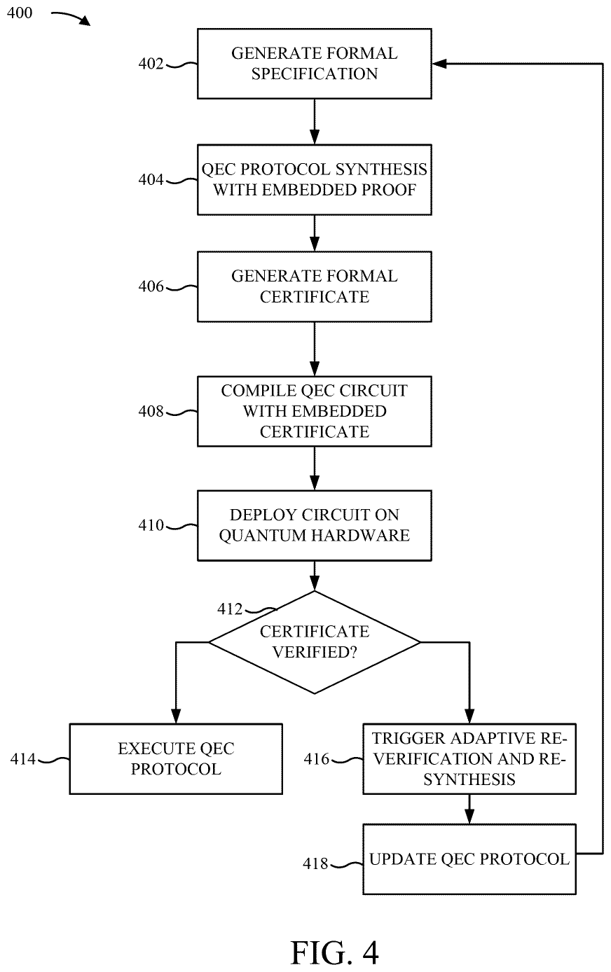

FIG. 4 is a flow diagram of a method for proof-carrying quantum error correction, in accordance with certain embodiments of the present disclosure. The flow diagram 400 depicts a process that may be performed by the computing platform 102, described above with reference to FIG. 1, in conjunction with the quantum computing device 112 (FIG. 1). The flow diagram 400 includes a design-time synthesis phase, in which a quantum error correction protocol is formally specified, synthesized with an embedded proof, certified, compiled, and deployed, and a runtime phase, in which the deployed protocol is monitored, verified, and adaptively re-synthesized when conditions change. As shown in FIG. 4, the flow diagram 400 includes steps 402, 404, 406, 408, 410, 412, 414, 416, and 418.

At step 402, the flow diagram 400 includes generating a formal specification. Step 402 may include specifying, using a theorem prover (which may also be referred to as a proof assistant, a formal verification engine, or an automated reasoning system), one or more properties of a quantum error correction protocol in a formal language. A theorem prover is a software tool, either automated or interactive, that constructs, verifies, or discovers formal mathematical proofs using logical deduction. Examples of theorem provers include, but are not limited to, Lean, Coq, and Isabelle/HOL. The formal language used within the theorem prover may be tailored to express quantum information concepts with mathematical precision, including properties of quantum states, quantum channels, and error propagation.

The one or more properties specified at step 402 may include fault-tolerance of the quantum error correction protocol under a specified noise model. Fault-tolerance, in this context, refers to the property that the quantum error correction protocol continues to correct errors when the quantum computing hardware exhibits noise at or below a stated threshold, as characterized by the quantum threshold theorem. The one or more properties may further include correctness of at least one of an encoding map or a decoding map of the quantum error correction protocol. Correctness of an encoding map refers to the property that quantum information is accurately mapped from a logical representation to a physical representation across multiple physical qubits. Correctness of a decoding map refers to the property that quantum information is accurately recovered from the physical representation back to the logical representation after error correction has been applied. In some implementations, the one or more properties may further include adherence to specific error thresholds, distance properties of the code, or constraints on the number of physical qubits consumed per logical qubit.

The formal specification produced at step 402 serves as the input to the synthesis process at step 404. By expressing the desired properties in a machine-readable formal language, the specification establishes a precise, unambiguous target against which the subsequent synthesis and certification processes may be evaluated. The formal specification may be iteratively refined based on the characteristics of the target quantum computing hardware, the complexity of the computational task to be protected, and the available resource budget for error correction overhead.

At step 404, the flow diagram 400 includes performing quantum error correction (QEC) protocol synthesis with embedded proof. Step 404 may include synthesizing a quantum error correction protocol and a formal proof certificate. The formal proof certificate (which may also be referred to as a certificate, a machine-checkable certificate, or an embedded proof) is a machine-checkable proof that the quantum error correction protocol satisfies the one or more properties specified at step 402. The term “machine-checkable” means that the proof may be verified by a computer program without human intervention, in contrast to an informal argument or empirical observation. The synthesis at step 404 produces a paired combination of the quantum error correction protocol and the formal proof certificate as a unified output.

In some implementations, the synthesizing at step 404 may include performing an AI-assisted proof search to generate the formal proof certificate. An AI-assisted proof search uses machine learning techniques to guide the theorem prover toward discovering a valid proof more efficiently than unguided exhaustive search. The AI-assisted proof search may employ neural network-based premise selection, reinforcement learning-guided tactic application, or language model-based proof generation to accelerate the search for a proof that the synthesized protocol satisfies the formal specification. In some implementations, the synthesis process at step 404 may iterate through multiple candidate protocols before identifying a candidate for which a valid formal proof may be constructed.

The quantum error correction protocol synthesized at step 404 may include at least one of a stabilizer code, a concatenated code, or a topological code. A stabilizer code encodes logical qubits into a larger number of physical qubits using a set of stabilizer operators that define the code space and provide a mechanism for detecting errors through stabilizer measurements. A concatenated code applies multiple layers of error correction by encoding each physical qubit of an inner code as a logical qubit of an outer code, thereby achieving error suppression that improves with each level of concatenation. A topological code arranges physical qubits on a lattice and exploits the topological properties of the lattice to detect and correct errors based on the positions of detected syndromes. In some implementations, the quantum error correction protocol synthesized at step 404 may define a stabilizer measurement schedule, encoding circuits, and decoding circuits. The stabilizer measurement schedule specifies the order and timing with which stabilizer operators are measured to extract error syndromes. The encoding circuits specify the quantum gate sequences that map logical qubit states into the physical code space. The decoding circuits specify the quantum gate sequences and classical processing that recover the logical qubit state from the measured syndromes and the physical qubit states.

At step 406, the flow diagram 400 includes generating a formal certificate. Step 406 may include producing the formal proof certificate as a standalone, machine-checkable artifact that accompanies the quantum error correction protocol synthesized at step 404. The formal proof certificate may encode, in the formal language of the theorem prover, a complete chain of logical deductions demonstrating that the quantum error correction protocol satisfies each of the one or more properties specified at step 402. The formal proof certificate may be checked independently of the synthesis process, meaning that a separate verification tool may confirm the validity of the proof without re-running the synthesis or the proof search.

The formal proof certificate produced at step 406 may be paired with the quantum error correction protocol as an inseparable unit, such that the protocol and the certificate are maintained together throughout subsequent compilation, deployment, and runtime operations. In some implementations, the formal proof certificate may be encoded as a serialized proof term in the native format of the theorem prover (for example, as a Lean proof term, a Coq proof object, or an Isabelle/HOL proof certificate). In some implementations, the formal proof certificate may be translated into a compact representation optimized for efficient verification, such as a proof-carrying certificate format that reduces the size of the proof while retaining its machine-checkable properties.

At step 408, the flow diagram 400 includes compiling the quantum error correction protocol into a quantum circuit with the formal proof certificate embedded in the quantum circuit. Step 408 takes the certified combination of the quantum error correction protocol and the formal proof certificate and produces a quantum circuit that is ready for deployment on quantum computing hardware. This process is analogous to proof-carrying code in classical software verification, in which a compiled program carries a machine-checkable proof of the safety properties of the program. In the quantum context, the quantum circuit includes the gate sequences, qubit allocations, measurement schedules, and classical feedback logic that implement the quantum error correction protocol.

The formal proof certificate may be embedded in the quantum circuit at step 408 in one or more forms. In some implementations, the formal proof certificate may be embedded as metadata associated with the quantum circuit, stored alongside the circuit description in a structured data format. In some implementations, the formal proof certificate may be embedded as annotations within the intermediate representation of the quantum circuit, such that each gate or sub-circuit carries a reference to the portion of the proof that certifies its correctness. In some implementations, the formal proof certificate may be embedded as auxiliary classical data that accompanies the quantum circuit and is accessible to classical control hardware during deployment and runtime verification. The output of step 408 is a proof-carrying quantum circuit: a compiled quantum circuit that carries, within its representation, a machine-checkable guarantee that the error correction protocol it implements satisfies the specified properties.

At step 410, the flow diagram 400 includes deploying the quantum circuit onto quantum computing hardware. The proof-carrying quantum circuit compiled at step 408 may be deployed onto the quantum computing device 112, described above with reference to FIG. 1. Deployment may include transmitting the compiled quantum circuit and its associated certificate data from the computing platform 102 (FIG. 1) to the classical control electronics of the quantum computing device 112, configuring the qubit control parameters, initializing the physical qubits into the code space defined by the encoding circuits, and beginning execution of the stabilizer measurement schedule. Once deployed, the quantum error correction protocol enters runtime operation, in which stabilizer measurements are performed according to the measurement schedule, error syndromes are extracted and decoded, and corrections are applied to the physical qubits.

Steps 402 through 410 collectively represent the design-time synthesis and deployment phase of the flow diagram 400. Steps 402 through 408, and steps 416 through 418 described below, may be performed by the computing platform 102 (FIG. 1). The design-time phase transforms a formal specification of desired error correction properties into a deployed, proof-carrying quantum circuit executing on quantum computing hardware.

At step 412, the flow diagram 400 includes a decision step in which a determination is made whether the certificate is verified. Step 412 may include monitoring operation of the quantum computing hardware to obtain operational data (which may also be referred to as runtime data, monitoring data, or syndrome data). The operational data may include error syndromes extracted from stabilizer measurements during QEC operation, gate fidelity measurements obtained through periodic calibration routines, qubit coherence time measurements, and statistical summaries of error rates observed over a monitoring window. Step 412 may further include verifying, based on the operational data, whether the formal proof certificate remains valid under current operating conditions of the quantum computing hardware.

In some implementations, the verifying at step 412 may include executing a lightweight certificate verification routine on classical computing hardware coupled to the quantum computing hardware. The lightweight certificate verification routine may check the formal proof certificate quickly without re-running the full synthesis and proof search process performed at steps 402 through 406. The lightweight certificate verification routine may evaluate whether the assumptions encoded in the formal proof certificate, such as the noise model parameters and error rate bounds, remain consistent with the operational data observed from the quantum computing hardware. In some implementations, the classical computing hardware on which the lightweight certificate verification routine executes may include field-programmable gate arrays (FPGAs) for low-latency monitoring, conventional central processing units (CPUs), or dedicated application-specific integrated circuits (ASICs) integrated into the quantum control system.

In some implementations, the verification at step 412 may be performed as a full certificate check, in which the complete formal proof is re-verified against the current operational data. In some implementations, the verification at step 412 may be performed as a probabilistic spot-check, in which selected portions of the formal proof are re-verified to provide a statistical confidence level that the certificate remains valid. In some implementations, the verification at step 412 may be performed continually, periodically, or in response to a trigger event such as a detected spike in error rates or a scheduled calibration cycle. The verification at step 412 produces a binary determination: either the certificate is verified (YES), or the certificate is not verified (NO). The flow diagram 400 branches based on this determination.

At step 414, the flow diagram 400 includes executing the quantum error correction protocol. Step 414 corresponds to the YES branch of the decision step 412, in which the formal proof certificate has been determined to remain valid under the current operating conditions. When the certificate is verified, the quantum error correction protocol continues executing on the quantum computing hardware as deployed, providing error correction services to the quantum computation being performed. The quantum computing hardware continues performing stabilizer measurements, extracting error syndromes, and applying corrections according to the encoding circuits, decoding circuits, and stabilizer measurement schedule defined by the quantum error correction protocol. During execution at step 414, the monitoring and verification operations described in connection with step 412 may continue, such that subsequent changes in the operating conditions of the quantum computing hardware may be detected and the certificate may be re-evaluated.

At step 416, the flow diagram 400 includes triggering adaptive re-verification and re-synthesis. Step 416 corresponds to the NO branch of the decision step 412, in which the formal proof certificate has been determined to no longer remain valid under the current operating conditions of the quantum computing hardware. The failure of certificate verification at step 412 indicates that the assumptions upon which the formal proof was predicated, such as the noise model, error rates, or coherence properties, have changed to a degree that the proof no longer holds for the current state of the hardware. At step 416, the process may include characterizing a current noise model of the quantum computing hardware based on the operational data obtained during the monitoring described in connection with step 412.

Characterizing the current noise model at step 416 may include analyzing the operational data to construct a mathematical description of the types and rates of errors that the quantum computing hardware is currently exhibiting. In some implementations, the noise characterization may be performed using quantum process tomography, in which a set of known input states is prepared and measured to reconstruct the quantum channel describing the noise process. In some implementations, the noise characterization may be performed using randomized benchmarking, in which sequences of random quantum gates are applied and the decay of the average fidelity is measured to extract an average error rate per gate. In some implementations, the noise characterization may be performed using gate set tomography, which provides a detailed characterization of the noise affecting each gate in the gate set. In some implementations, the noise characterization may use simplified noise proxy measurements that extract key noise parameters without performing full tomographic reconstruction.

At step 418, the flow diagram 400 includes updating the quantum error correction protocol. Step 418 may include re-synthesizing an updated quantum error correction protocol and an updated formal proof certificate based on the current noise model characterized at step 416. The re-synthesis at step 418 may use the same formal synthesis process described in connection with steps 402 through 406, but with specifications updated to reflect the current noise conditions of the quantum computing hardware. The updated formal specification may incorporate the current noise model parameters, updated error rate bounds, and revised fault-tolerance thresholds derived from the noise characterization performed at step 416.

As shown in FIG. 4, after step 418, the flow diagram 400 returns to step 402, where the formal specification is re-generated with the updated parameters. The process then proceeds through step 404 (synthesizing an updated quantum error correction protocol and an updated formal proof certificate), step 406 (generating the updated formal proof certificate), step 408 (compiling the updated quantum error correction protocol into an updated quantum circuit with the updated formal proof certificate embedded therein), and step 410 (deploying the updated quantum circuit onto the quantum computing hardware to replace the quantum circuit previously deployed). This return path from step 418 to step 402 represents a full re-synthesis loop in which the design-time synthesis pipeline is re-executed with updated specifications reflecting the changed noise conditions, rather than a partial restart at a later stage of the pipeline.

The combination of steps 410 through 418 of the flow diagram 400 forms a hybrid classical-quantum feedback loop that integrates classical real-time monitoring with the formal verification backend. In this feedback loop, the quantum computing hardware operates the deployed quantum error correction protocol while classical computing hardware concurrently monitors the operational data, verifies the formal proof certificate, and triggers adaptive re-synthesis when the certificate is no longer valid. The hybrid classical-quantum feedback loop converts a static, one-time verification of the quantum error correction protocol into a dynamic, self-adapting system that responds to changes in the noise characteristics of the quantum computing hardware by re-synthesizing a protocol with updated formal guarantees. In some implementations, the hybrid classical-quantum feedback loop may operate with configurable sensitivity thresholds that control how much deviation from the assumed noise model is tolerated before triggering re-synthesis. In some implementations, the hybrid classical-quantum feedback loop may maintain a history of prior noise characterizations and prior certificates to accelerate the re-synthesis process by providing warm-start data to the synthesis engine.

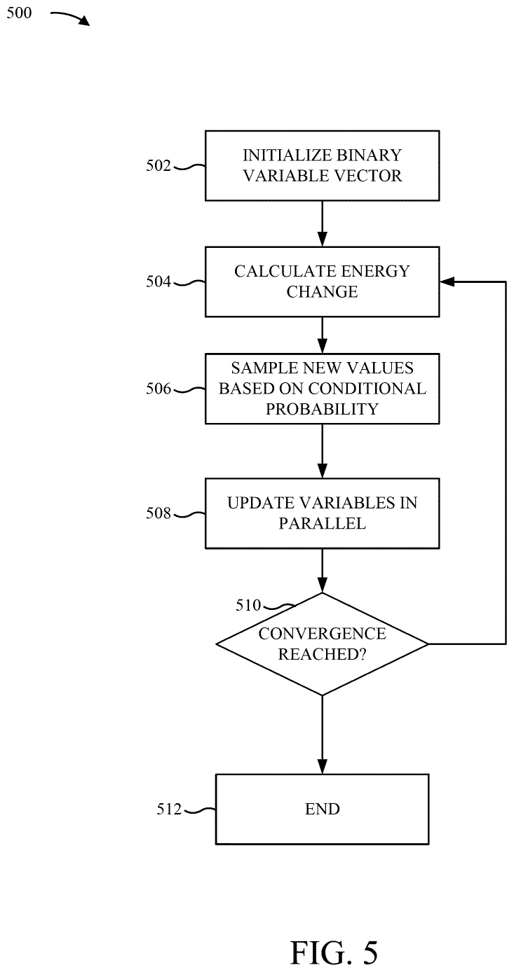

FIG. 5 is a flow diagram of a method for Gibbs sampling using a probabilistic computing device, in accordance with certain embodiments of the present disclosure. The flow diagram 500 depicts a process that may be performed using the probabilistic computing device 114, described above with reference to FIG. 1. Steps 402 through 408 and 416 through 418 described in connection with the flow diagram 400 (FIG. 4) may be performed by the computing platform 102 (FIG. 1). As shown in FIG. 5, the flow diagram 500 includes steps 502, 504, 506, 508, 510, and 512.

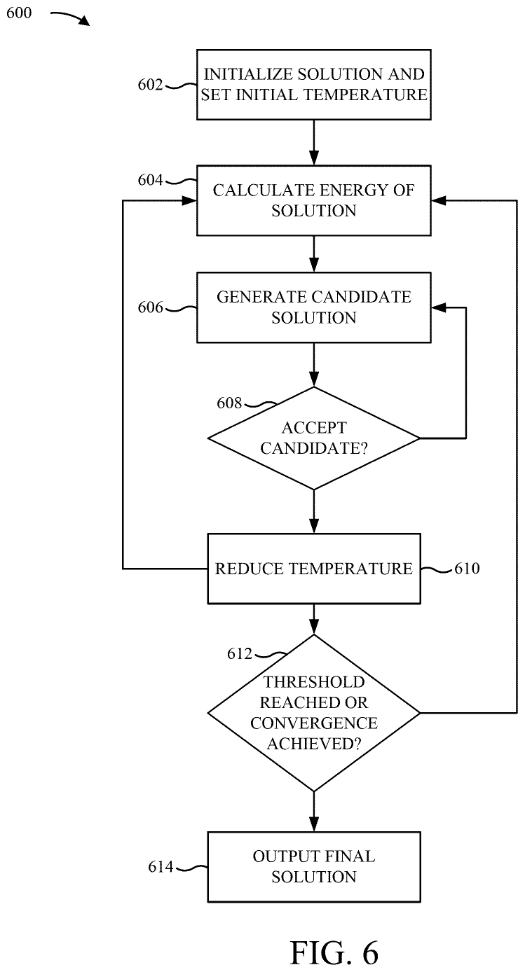

The flow diagram 500 describes one of several methods by which the probabilistic computing device 114 may be used to perform a computational task. Abroad class of computational tasks, including high-dimensional integration, combinatorial optimization, model distillation, Bayesian inference, and generative modeling, may be addressed by generating samples from probability distributions. On conventional computing hardware, such sampling is performed in software using pseudo-random number generators and iterative algorithms such as Markov Chain Monte Carlo (MCMC) methods. The probabilistic computing device 114, described above with reference to FIG. 1, comprises hardware that natively generates samples from a probability distribution, meaning that the sampling process is carried out by the physical dynamics of the hardware rather than by iterative software routines. The flow diagram 500 and the flow diagrams described in connection with FIGS. 6, 7, and 8 below each depict a distinct sampling or optimization method that leverages this native hardware sampling capability.

The methods depicted in FIGS. 5 through 8 share a common energy-based framework. In this framework, a computational task is received, and an energy function is determined that maps configurations of variables to energy values. The energy function encodes a structure of the computational task as a probability distribution. The probability distribution may take the Boltzmann form:

$${p}_{θ} ( x ) = \frac{1}{Z} {e}^{- {E}_{θ} ( x )}$$

where θ represents a set of tunable parameters (which may also be referred to as weights or coupling constants), x represents a configuration of variables in the sampling domain (which may include binary variables, discrete variables, or continuous variables), E_{θ} represents the energy function that maps the configuration x to an energy value, and Z represents a normalization factor (which may also be referred to as the partition function) defined as Z=∫e^{-E}^{_{θ}}^{(x)}dx. Under this distribution, configurations with lower energy values have higher probability, such that the structure of the computational task, including solutions, optima, or statistical properties, is represented in the probability landscape of the distribution. The probabilistic computing device 114 is configured with the parameters theta of the energy function, and the probabilistic computing device 114 generates a plurality of samples from the probability distribution. A result of the computational task is determined based on the plurality of samples.

In some implementations, the parameters θ of the energy function may be trained prior to or during the sampling process. Training the parameters of the energy function may include iteratively generating samples from the probabilistic computing device 114 and adjusting the parameters to reduce a divergence between the probability distribution realized on the probabilistic computing device 114 and a target distribution associated with the computational task. The divergence may include a Kullback-Leibler (KL) divergence, and the adjustment may be performed using gradient descent, contrastive divergence, persistent contrastive divergence, score matching, or other optimization algorithms for energy-based models.

The flow diagram 500 depicts a Gibbs sampling process, which is one method by which the probabilistic computing device 114 may generate samples from the probability distribution defined by the energy function. Gibbs sampling is an iterative process in which individual variables (or groups of variables) are updated by sampling from their conditional distributions given the current values of all other variables. The flow diagram 500 may be applied to a variety of computational tasks, including combinatorial optimization tasks defined over binary variables and high-dimensional integration tasks. A primary exemplary application of the flow diagram 500 is Multiple-Input Multiple-Output (MIMO) signal decoding in wireless communication systems, described in greater detail below.

In MIMO wireless communication, multiple antennas at both a transmitter and a receiver improve communication performance by exploiting spatial diversity. The received signal is modeled as:

$$y = Hx + n$$

where y is a received signal vector, H is a channel matrix representing the linear transformation imposed by the propagation environment, x is a transmitted symbol vector (with symbols drawn from a modulation set such as binary phase shift keying (BPSK), quadrature phase shift keying (QPSK), or 16-quadrature amplitude modulation (16-QAM)), and n is a Gaussian noise vector. The goal of MIMO decoding is to determine the most likely transmitted symbol vector x given the received signal vector y and the channel matrix H. This decoding objective may be formulated as a Quadratic Unconstrained Binary Optimization (QUBO) problem by minimizing the Euclidean distance between the received signal and the expected signal:

$$minimize {‖ y - Hx ‖}^{2}$$

The QUBO formulation maps directly to an energy function E_{θ}(x)=∥y−Hx∥\hat{ }2, where the configuration of binary variables x corresponds to the candidate transmitted symbols and the energy value corresponds to the decoding error. The probabilistic computing device 114 may be configured with the parameters of this energy function, and the Gibbs sampling process depicted in the flow diagram 500 may be used to generate samples from the resulting probability distribution to identify the minimum-energy configuration corresponding to the decoded signal.

At step 502, the flow diagram 500 includes initializing a binary variable vector. Step 502 may include setting a vector of binary variables v (v₁, v₂, . . . , vₙ) to an initial configuration, where each binary variable v, takes a value of 0 or 1. In the context of MIMO decoding, the binary variable vector v may represent a candidate transmitted symbol vector. The initialization may be performed randomly, in which each variable vᵢ is assigned a value of 0 or 1 with equal probability, or using a heuristic-based initialization, in which the initial values are derived from a low-complexity decoding method such as zero-forcing or minimum mean square error (MMSE) detection. The probabilistic computing device 114 may be configured with the parameters of the energy function prior to or concurrently with the initialization at step 502, such that the hardware is prepared to evaluate energy values and generate samples from the corresponding probability distribution.

At step 504, the flow diagram 500 includes calculating energy change. Step 504 may include computing, for each variable vᵢ in the binary variable vector v, a change in energy (ΔEᵢ) that would result from flipping the value of the variable vᵢ from its current value to the opposite value. The change in energy ΔEᵢ quantifies how the energy of the overall configuration would change if the variable vᵢ were toggled while all other variables v_{{-i}} remain fixed. The probabilistic computing device 114 may perform this energy change calculation using hardware-accelerated energy evaluation, in which dedicated hardware circuits compute ΔEᵢ in constant time per variable, rather than in time proportional to the number of variables as in software-based implementations. For energy functions in QUBO form, the energy change computation reduces to a sum of products involving the coupling coefficients and the current values of neighboring variables, which the hardware of the probabilistic computing device 114 may evaluate through parallel arithmetic circuits.

At step 506, the flow diagram 500 includes sampling new values based on conditional probability. Step 506 may include computing, for each variable vᵢ, a conditional probability of the variable vᵢ taking the value 1 given the current values of all other variables v_{{-i}}. The conditional probability is derived from the Gibbs conditional formula:

$$p ( {v}_{i} = 1 \vert {v}_{\{ - i \}} ) = \frac{1}{1 + exp ( Δ Ei )}$$

where ΔEᵢ is the energy change computed at step 504. This conditional probability represents the probability that the variable vᵢ should be set to 1 under the Boltzmann distribution defined by the energy function, conditioned on the current values of the remaining variables. At step 506, a new value for each variable vᵢ is sampled from this conditional distribution: the variable vᵢ is set to 1 with probability p(vᵢ=1|v_{{-i}}) and set to 0 with the complementary probability. The probabilistic computing device 114 may perform this conditional sampling natively in hardware, using stochastic circuits or noise-driven switching elements that generate random outcomes weighted by the computed conditional probabilities.

At step 508, the flow diagram 500 includes updating variables in parallel. Step 508 may include applying the sampled values computed at step 506 to update multiple variables in the binary variable vector v simultaneously. In traditional sequential Gibbs sampling performed in software on conventional processors, variables are updated one at a time in a fixed or random order, with each update depending on the most recent values of all other variables. The probabilistic computing device 114 may perform parallelized variable updates in which multiple variables are sampled and updated concurrently within a single hardware clock cycle or a small number of hardware clock cycles. This parallelized update capability is a property of the hardware architecture of the probabilistic computing device 114, which may include independent sampling circuits for each variable or for groups of variables that are conditionally independent given the remaining variables.

The parallelized variable updates at step 508 may reduce the time to convergence by a factor proportional to the number of variables updated in parallel, as compared to sequential Gibbs sampling in which each iteration updates a single variable. In some implementations, the probabilistic computing device 114 may maintain convergence guarantees for the parallelized updates by grouping variables into conditionally independent sets (that is, sets of variables that are mutually independent given the values of all variables outside the set) and updating all variables within a set simultaneously before proceeding to the next set. In some implementations, the parallelized updates may be performed using a chromatic scheduling approach, in which the variables are colored according to a graph coloring of the interaction graph defined by the energy function, and all variables of the same color are updated simultaneously.

At step 510, the flow diagram 500 includes a decision step in which a determination is made whether convergence has been reached. Convergence may be assessed by evaluating whether the energy of the binary variable vector v has stabilized below a threshold, whether the distribution of sampled values has reached a stationary distribution, or whether a predetermined number of iterations has been completed. If convergence has not been reached (NO), the flow diagram 500 returns to step 504, where the energy change calculation is repeated for the updated binary variable vector v, and steps 506 and 508 are performed again with the updated values. The iterative loop through steps 504, 506, 508, and 510 continues until the convergence criterion is satisfied. If convergence has been reached (YES), the flow diagram 500 proceeds to step 512.

At step 512, the flow diagram 500 terminates. The final state of the binary variable vector v at the time convergence is reached represents the result of the computational task. In the context of a combinatorial optimization task defined over binary variables, such as the MIMO decoding example described above, determining the result may include selecting, from the plurality of samples generated during the iterative process, a sample having a minimum energy value. The minimum-energy sample corresponds to the configuration of binary variables that minimizes the energy function and thus represents the best solution found by the Gibbs sampling process. In the MIMO decoding context, this minimum-energy configuration corresponds to the decoded transmitted symbol vector. In some implementations, the computational task may comprise a high-dimensional integration task, and determining the result may include computing an expectation of a function over the plurality of samples generated by the probabilistic computing device 114. For example, in derivative pricing applications, the plurality of samples may represent asset price scenarios drawn from a risk-neutral distribution modeled by the energy function, and the result may be computed as a discounted average of payoff values evaluated at the sampled scenarios.

In some implementations, the computational task may comprise distilling a teacher model into a student model. The teacher model (which may also be referred to as a source model, a high-capacity model, or a reference model) is a trained model, such as a large language model or a diffusion model, that produces an output distribution. The student model is the probability distribution realized on the probabilistic computing device 114. In the distillation context, the parameters of the energy function may be trained by minimizing a divergence between the output distribution of the teacher model and the probability distribution on the probabilistic computing device 114. Once trained, the student model running on the probabilistic computing device 114 may generate samples at lower latency and lower power consumption than the teacher model running on conventional hardware. The Gibbs sampling process depicted in the flow diagram 500 may serve as the inference-time sampling mechanism for the distilled student model.

The energy-based framework and the Gibbs sampling process described in connection with the flow diagram 500 may be applied to additional computational tasks beyond those described above. In some implementations, the probabilistic computing device 114 may be configured to sample from experimental design distributions in high-dimensional chemical and biological systems, approximate posterior distributions in Bayesian inference for few-shot learning and uncertainty-aware decision-making, enhance reinforcement learning exploration strategies by sampling from energy-based models, accelerate probabilistic inference within probabilistic programming frameworks, model energy landscapes in protein folding and molecular structure prediction, generate stable material structures in generative design applications, perform structured high-dimensional sampling for analyzing vulnerabilities in security protocols, or synthesize rare-event distributions for improving the robustness of anomaly detection models. The simulated annealing, parallel tempering, and hybrid adaptive sampling methods described in connection with FIGS. 6, 7, and 8, respectively, provide alternative approaches for generating samples from or optimizing over the energy-based probability distribution, each with distinct characteristics suited to different classes of computational tasks.

FIG. 6 is a flow diagram of a method for simulated annealing using a probabilistic computing device, in accordance with certain embodiments of the present disclosure. The flow diagram 600 depicts a process that may be performed using the probabilistic computing device 114, described above with reference to FIG. 1. The flow diagram 600 provides an alternative approach to the Gibbs sampling process described in connection with the flow diagram 500 (FIG. 5) for generating samples from, or optimizing over, the energy-based probability distribution. Whereas the flow diagram 500 (FIG. 5) performs Gibbs sampling at a fixed temperature, the flow diagram 600 introduces a temperature parameter that is progressively reduced according to a cooling schedule, thereby controlling the balance between exploration of the solution space and exploitation of low-energy regions. The energy function and Boltzmann distribution described above with reference to FIG. 5 govern the candidate generation and acceptance operations in the flow diagram 600. As shown in FIG. 6, the flow diagram 600 includes steps 602, 604, 606, 608, 610, 612, and 614.

The flow diagram 600 includes two nested iterative loops. An inner loop, formed by the path from decision step 608 back to step 606, generates and evaluates candidate solutions at a given temperature until a candidate is accepted. An outer loop, formed by the path from decision step 612 back to step 604, repeats the candidate generation and acceptance process at progressively lower temperatures until a convergence criterion is satisfied or a temperature threshold is reached. This two-loop structure distinguishes simulated annealing from the single-loop Gibbs sampling process of FIG. 5 and provides a mechanism by which the process may escape local energy minima at high temperatures while converging toward a global or near-global energy minimum as the temperature decreases.

At step 602, the flow diagram 600 includes initializing a solution and setting an initial temperature. Step 602 may include setting a solution vector v (v₁, v₂, . . . , vₙ) to an initial configuration and setting a temperature parameter T to a high initial value T₀. The initial configuration of the solution vector v may be assigned randomly, in which each variable is assigned a value drawn uniformly from the variable domain, or using a heuristic-based initialization derived from a low-complexity solver. The initial temperature T₀ may be set to a value high enough that the Boltzmann distribution at temperature T₀ is approximately uniform over the solution space, meaning that the acceptance probability for candidate solutions with higher energy than the current solution is close to 1. This high initial temperature provides broad exploration of the solution space in the early stages of the process. In some implementations, the initial temperature T₀ may be determined by computing sample energy differences over a set of random configurations and selecting a value such that a target fraction of uphill moves (for example, 80 percent or 90 percent) would be accepted.

At step 604, the flow diagram 600 includes calculating the energy of the solution. Step 604 may include computing an energy value E(v) for the current solution vector v using the energy function described above with reference to FIG. 5. The probabilistic computing device 114 (FIG. 1) may perform this energy calculation using hardware-accelerated energy evaluation, as described above with reference to the flow diagram 500 (FIG. 5). The computed energy value E(v) serves as the reference against which candidate solutions generated at step 606 are evaluated.

At step 606, the flow diagram 600 includes generating a candidate solution. Step 606 may include sampling a new candidate solution v′ from a neighborhood of the current solution vector v. The candidate solution v′ may be generated by perturbing one or more variables in the current solution vector v, such as by flipping the value of a randomly selected binary variable, swapping the values of two variables, or applying a local move operator defined for the problem domain. In some implementations, the generation of the candidate solution v′ may incorporate the current temperature T, such that at higher temperatures the perturbation may involve larger changes to the solution vector (broader neighborhood exploration), while at lower temperatures the perturbation may involve smaller changes (local refinement). The probabilistic computing device 114 (FIG. 1) may accelerate the candidate generation at step 606 by sampling from the Boltzmann distribution at the current temperature T, producing candidate solutions that are weighted according to their energy values at the current temperature.

At step 608, the flow diagram 600 includes a decision step in which a determination is made whether to accept the candidate solution. Step 608 may include computing a change in energy ΔE=E(v′)−E(v), where E(v′) is the energy of the candidate solution v′ generated at step 606 and E(v) is the energy of the current solution vector v computed at step 604 (or as updated in a prior iteration of the outer loop). The acceptance determination at step 608 may be performed using the Metropolis criterion, in which the candidate solution v′ is accepted with an acceptance probability:

$${P}_{accept} = min ( 1 , exp ( - Δ E / T ) )$$

where T is the current temperature. Under the Metropolis criterion, if the candidate solution v′ has lower energy than the current solution v (ΔE<0), the acceptance probability is 1 and the candidate is accepted unconditionally. If the candidate solution v′ has higher energy than the current solution v (ΔE>0), the candidate is accepted with a probability that decreases as the energy difference increases and as the temperature decreases.

This probabilistic acceptance mechanism provides a mechanism by which the simulated annealing process may escape local energy minima. At high temperatures, the acceptance probability for higher-energy candidate solutions is relatively large, meaning that the process may move to configurations with higher energy in order to explore regions of the solution space that are separated from the current configuration by energy barriers. As the temperature decreases, the acceptance probability for higher-energy candidates diminishes, and the process becomes increasingly greedy, favoring moves that decrease the energy. In the limit as T approaches zero, the process accepts lower-energy candidates and rejects all higher-energy candidates.

If the candidate solution v′ is not accepted at step 608 (NO), the flow diagram 600 returns to step 606, where a new candidate solution is generated. This inner loop between steps 606 and 608 may repeat multiple times at a given temperature until a candidate is accepted. If the candidate solution v′ is accepted at step 608 (YES), the current solution vector v is updated to the accepted candidate (v=v′), and the flow diagram 600 proceeds to step 610.

At step 610, the flow diagram 600 includes reducing the temperature. Step 610 may include decreasing the temperature parameter T according to a cooling schedule. The cooling schedule defines how the temperature is reduced over the course of the annealing process and affects the trade-off between the thoroughness of the search and the speed of convergence. In some implementations, the cooling schedule may be a geometric cooling schedule, in which the temperature is multiplied by a constant factor alpha (where 0<α<1) at each temperature reduction step, such that T_{new}=α*T. In some implementations, the cooling schedule may be a linear cooling schedule, in which the temperature is decreased by a constant amount at each step. In some implementations, the cooling schedule may be an adaptive cooling schedule, in which the rate of temperature reduction is adjusted dynamically based on the observed convergence rate of the process. For example, the temperature may be reduced more slowly when the process is still finding improved solutions (indicating that further exploration at the current temperature is productive) and reduced more rapidly when the process has stagnated at the current temperature. The probabilistic computing device 114 (FIG. 1) may support dynamic temperature adaptation by accepting updated temperature parameters and adjusting the sampling distribution accordingly with low latency.

At step 612, the flow diagram 600 includes a decision step in which a determination is made whether a threshold has been reached or convergence has been achieved. Step 612 may include evaluating one or more termination criteria, such as whether the temperature T has fallen below a predefined minimum temperature threshold Tₘᵢₙ, whether the energy of the current solution has not improved by more than a specified tolerance over a specified number of temperature reduction steps, or whether a maximum number of outer-loop iterations has been reached. If the termination criteria have not been satisfied (NO), the flow diagram 600 returns to step 604, where the energy of the current solution vector v (as updated through acceptance at step 608) is calculated at the new, reduced temperature, and the candidate generation and acceptance process resumes at the lower temperature. This outer loop between steps 604 and 612 drives the progressive cooling that characterizes simulated annealing. If the termination criteria have been satisfied (YES), the flow diagram 600 proceeds to step 614.

At step 614, the flow diagram 600 includes outputting a final solution. The final solution output at step 614 is the current solution vector v at the time the termination criteria at step 612 are satisfied. The final solution vector v represents the configuration of variables having the lowest energy value found through the simulated annealing process. In the context of a combinatorial optimization task defined over binary variables, such as those described above with reference to FIG. 5, the result of the computational task may be determined by selecting, from the plurality of samples generated during the annealing process, a sample having a minimum energy value. In some implementations, the flow diagram 600 may maintain a record of the lowest-energy configuration encountered during the annealing process, separate from the current solution, such that the final output at step 614 reflects the global best configuration found across all iterations rather than the configuration at the time of termination.

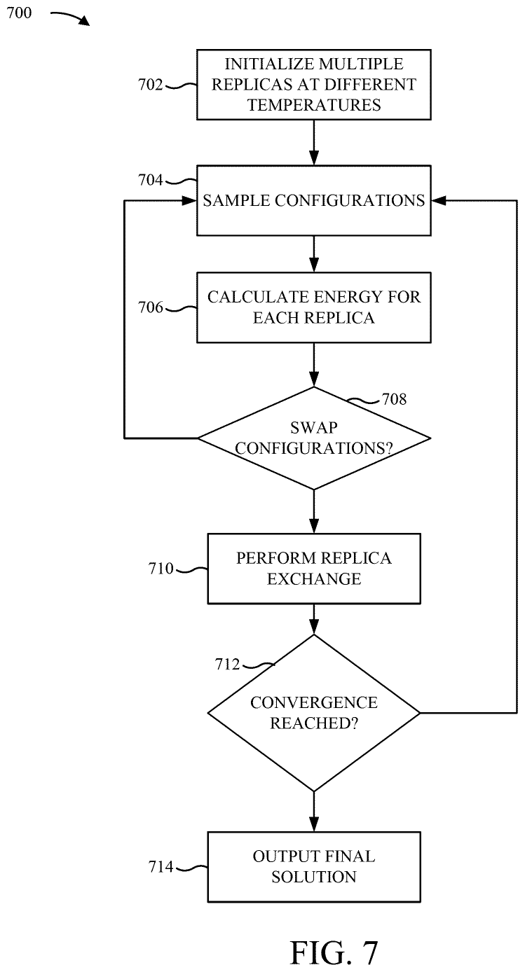

FIG. 7 is a flow diagram of a method for parallel tempering using a probabilistic computing device, in accordance with certain embodiments of the present disclosure. The flow diagram 700 depicts a process that may be performed using the probabilistic computing device 114, described above with reference to FIG. 1. The flow diagram 700 provides an alternative approach to the Gibbs sampling process described in connection with the flow diagram 500 (FIG. 5) and the simulated annealing process described in connection with the flow diagram 600 (FIG. 6) for optimizing over the energy-based probability distribution. Whereas the flow diagram 600 (FIG. 6) operates a single solution through a sequence of progressively decreasing temperatures, the flow diagram 700 operates multiple replicas of the system simultaneously, each at a different fixed temperature, and periodically exchanges configurations between replicas to combine the benefits of broad exploration at high temperatures with local refinement at low temperatures. As shown in FIG. 7, the flow diagram 700 includes steps 702, 704, 706, 708, 710, 712, and 714.

At step 702, the flow diagram 700 includes initializing multiple replicas at different temperatures. Step 702 may include creating K replicas of the system, where each replica k (for k=1, 2, . . . , K) is associated with a respective temperature T_k and an independent configuration vector v_k=(v_{k,1}, v_{k,2}, . . . , v_{k,n}). The temperatures may be arranged in ascending order T_1<T_2< . . . <T_K, such that the first replica operates at the lowest temperature and the K-th replica operates at the highest temperature. Each configuration vector v_k may be initialized randomly or using a heuristic-based initialization.

The multi-replica structure at step 702 leverages the relationship between temperature and sampling behavior described in connection with the flow diagram 600 (FIG. 6). Replicas at low temperatures sample predominantly from low-energy regions of the solution space, performing local refinement around promising configurations. Replicas at high temperatures sample more broadly across the solution space, including regions separated by energy barriers that low-temperature replicas may not traverse. By maintaining replicas at multiple temperatures simultaneously, the flow diagram 700 provides concurrent exploration at multiple scales of the energy landscape. In some implementations, the number K of replicas and the spacing of temperatures Tᵢ<T₂< . . . <Tₖ may be predetermined based on the dimensionality and expected ruggedness of the energy landscape. In some implementations, the temperature spacing may be geometric, such that Tₖ+1/Tₖ is constant across all adjacent pairs. In some implementations, the probabilistic computing device 114 (FIG. 1) may operate all K replicas in parallel if the hardware capacity is sufficient, or the replicas may be time-multiplexed on the probabilistic computing device 114.

At step 704, the flow diagram 700 includes sampling configurations. Step 704 may include, for each replica k, independently generating one or more sampled configurations from the probability distribution at the temperature Tₖ associated with that replica. Each replica may perform sampling using the Gibbs sampling process described in connection with the flow diagram 500 (FIG. 5) or using the candidate generation and Metropolis acceptance process described in connection with the flow diagram 600 (FIG. 6), applied at the respective temperature Tₖ. The probabilistic computing device 114 (FIG. 1) may generate samples for each replica independently, and when the replicas are operated in parallel, the sampling at step 704 may produce updated configurations for all K replicas concurrently.

At step 706, the flow diagram 700 includes calculating the energy for each replica. Step 706 may include computing an energy value E(vₖ) for the current configuration vector vₖ of each replica k, using the energy function described above with reference to FIG. 5. The probabilistic computing device 114 (FIG. 1) may perform the energy calculations for all K replicas using hardware-accelerated energy evaluation. The computed energy values serve as inputs to the replica exchange determination at step 708.

At step 708, the flow diagram 700 includes a decision step in which a determination is made whether to swap configurations between replicas. Step 708 may include selecting a pair of adjacent replicas (replica i at temperature Tᵢ and replica j at temperature Tⱼ, where Tᵢ<Tⱼ) and computing a swap probability:

$${p}_{swap} = min ( 1 , exp ( ( {β}_{i} - {β}_{j} ) ( E ( {v}_{i} ) - E ( {v}_{j} ) ) )$$

where βᵢ=1/Tᵢ and β=1=/Tⱼ are the inverse temperatures of the two replicas, and E(vᵢ) and E(vⱼ) are the energy values of their respective configurations computed at step 706. A random number is drawn uniformly between 0 and 1 and compared to p_{swap}; if the random number is less than p_{swap}, the swap is accepted, and otherwise the swap is rejected.

The replica exchange mechanism at step 708 provides a mechanism by which low-energy configurations discovered by high-temperature replicas may migrate to low-temperature replicas for further refinement. Under the swap probability formula, a swap is favorable when the lower-temperature replica has higher energy than the higher-temperature replica (that is, when E(vᵢ)>E(vⱼ)), because in that case the exponent (βᵢ−βⱼ)*(E(vᵢ)−E(vⱼ)) is positive and the swap probability approaches or reaches 1. This means that when a high-temperature replica discovers a low-energy configuration that the low-temperature replica has not yet found, the exchange is likely to be accepted, effectively injecting the high-temperature discovery into the low-temperature refinement process. Conversely, the high-temperature replica receives the higher-energy configuration from the low-temperature replica, which the high-temperature replica may then use as a starting point for further broad exploration. In some implementations, the swap evaluation at step 708 may be performed for all adjacent pairs of replicas in sequence, for a randomly selected pair, or for all pairs simultaneously.

If the swap is not accepted at step 708 (NO), the flow diagram 700 returns to step 704, where each replica continues sampling from its current configuration without exchanging configurations. As shown in FIG. 7, when the swap is rejected, the flow returns directly to step 704 without passing through the convergence check at step 712. If the swap is accepted at step 708 (YES), the flow diagram 700 proceeds to step 710.

At step 710, the flow diagram 700 includes performing the replica exchange. Step 710 may include swapping the configuration vectors between the two replicas selected at step 708, such that replica i receives the configuration vector vⱼ and replica j receives the configuration vector vᵢ. After the exchange, each replica continues to sample at its own fixed temperature, but starting from the newly received configuration. The temperatures of the replicas remain unchanged; the exchange involves the configurations, not the temperature assignments.

At step 712, the flow diagram 700 includes a decision step in which a determination is made whether convergence has been reached. Step 712 may include evaluating one or more convergence criteria across all K replicas, such as whether the energy of the lowest-temperature replica has stabilized, whether the distribution of configurations across replicas has reached a stationary state, or whether a predetermined number of iterations or replica exchanges has been completed. If convergence has not been reached (NO), the flow diagram 700 returns to step 704, where the replicas continue sampling with their current (post-exchange) configurations. If convergence has been reached (YES), the flow diagram 700 proceeds to step 714.

At step 714, the flow diagram 700 includes outputting a final solution. The final solution output at step 714 may be selected from the lowest-temperature replica (replica 1 at temperature T₁), which is the replica that has been performing the most focused local refinement throughout the process. The configuration vector vᵢ of the lowest-temperature replica at the time of convergence represents the lowest-energy configuration found through the combination of independent sampling, energy calculation, and replica exchange performed across all K replicas and all iterations of the flow diagram 700. In the context of a combinatorial optimization task defined over binary variables, as described above with reference to FIG. 5, the result may be determined by selecting, from the configurations maintained across all replicas, a configuration having a minimum energy value. In some implementations, the flow diagram 700 may maintain a global record of the lowest-energy configuration encountered across all replicas during the process, and the final solution output at step 714 may reflect this global best rather than the current state of the lowest-temperature replica at the time of convergence.

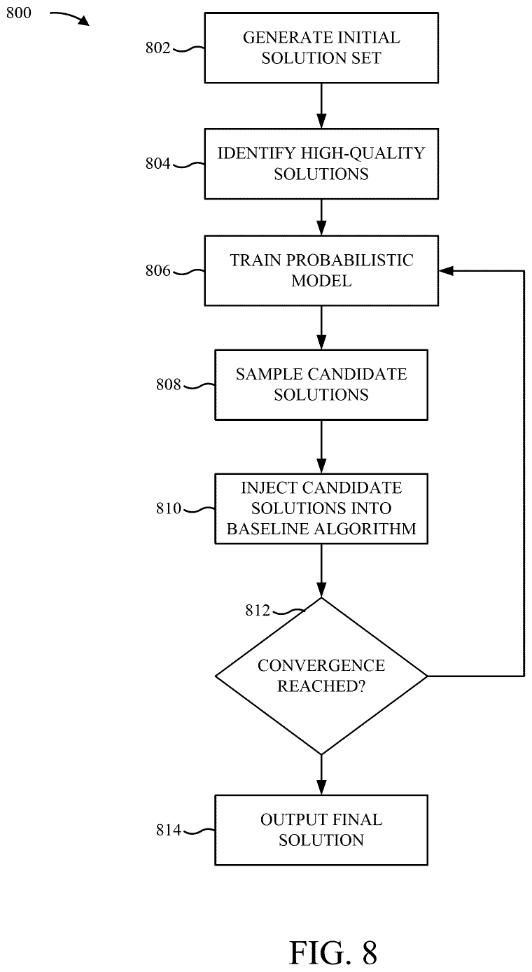

FIG. 8 is a flow diagram of a method for hybrid adaptive sampling using a probabilistic computing device, in accordance with certain embodiments of the present disclosure. The flow diagram 800 depicts a process in which a classical optimization algorithm operating on a classical processor cooperates with the probabilistic computing device 114, described above with reference to FIG. 1, to perform a computational task. Unlike the flow diagrams 500 (FIG. 5), 600 (FIG. 6), and 700 (FIG. 7), in which the probabilistic computing device 114 performs sampling independently, the flow diagram 800 introduces a hybrid architecture in which the probabilistic computing device 114 learns the distribution of high-quality solutions discovered by a classical optimization algorithm and generates new candidate solutions that are injected back into the classical optimization algorithm to augment the search. As shown in FIG. 8, the flow diagram 800 includes steps 802, 804, 806, 808, 810, 812, and 814.

At step 802, the flow diagram 800 includes generating an initial solution set. Step 802 may include initializing a classical optimization algorithm on a classical processor to generate an initial set of candidate solutions for the computational task. The classical optimization algorithm may include simulated annealing (as described in connection with the flow diagram 600 of FIG. 6), parallel tempering (as described in connection with the flow diagram 700 of FIG. 7), a genetic algorithm, a tabu search, or another metaheuristic optimization algorithm. The classical processor on which the classical optimization algorithm executes may be, be similar to, include, or be included in the conventional computing device 108 or the computing platform 102, described above with reference to FIG. 1. The initial set of candidate solutions generated at step 802 seeds the hybrid process with conventionally-generated solutions that reflect the exploration performed by the classical optimization algorithm during its initial execution.

At step 804, the flow diagram 800 includes identifying high-quality solutions. Step 804 may include identifying a subset of high-quality solutions from the initial set of candidate solutions generated at step 802 based on a cost function. The cost function evaluates each candidate solution in the initial set and assigns a quality score, and the subset of high-quality solutions may include candidate solutions whose quality scores satisfy a predefined quality threshold, a fixed number of the top-ranked solutions, or solutions selected according to a diversity-preserving selection criterion. The subset of high-quality solutions identified at step 804 serves as training data for the probabilistic model trained at step 806.

At step 806, the flow diagram 800 includes training a probabilistic model. Step 806 may include training the parameters of the energy function based on the subset of high-quality solutions such that the probability distribution approximates a distribution of the high-quality solutions. By training the energy function parameters so that the probability distribution realized on the probabilistic computing device 114 concentrates probability mass in regions of the solution space where high-quality solutions have been observed, the probabilistic computing device 114 may subsequently generate new candidate solutions that are likely to fall in promising regions that the classical optimization algorithm might not reach through its own search operations.

In some implementations, the probabilistic model trained at step 806 may be a Restricted Boltzmann Machine (RBM), in which the energy function is parameterized by visible-hidden biases and coupling weights. In some implementations, the probabilistic model may be a general Boltzmann machine, a Gaussian Mixture Model (GMM), a Variational Autoencoder (VAE), or a normalizing flow. The training at step 806 may include adjusting the tunable parameters theta of the energy function using gradient descent, contrastive divergence, persistent contrastive divergence, or other optimization algorithms, with the objective of minimizing a divergence between the distribution of the high-quality solutions identified at step 804 and the probability distribution realized on the probabilistic computing device 114. In some implementations, the training at step 806 may use the iterative parameter training process described above with reference to FIG. 5, in which samples are generated from the probabilistic computing device 114 and the parameters are adjusted to reduce the divergence between the realized distribution and the target distribution.

At step 808, the flow diagram 800 includes sampling candidate solutions. Step 808 may include generating, by the probabilistic computing device 114, a plurality of new candidate solutions by sampling from the probability distribution trained at step 806. Because the probability distribution has been trained to approximate the distribution of the high-quality solutions, the new candidate solutions generated at step 808 may explore regions of the solution space that are proximate to the known high-quality solutions while introducing stochastic variation that may yield improved configurations. The probabilistic computing device 114 (FIG. 1) may generate the plurality of new candidate solutions using the native hardware sampling capability described above with reference to FIG. 1, providing low-latency generation of samples that are concentrated in the promising regions identified through the training at step 806.

At step 810, the flow diagram 800 includes injecting candidate solutions into a baseline algorithm. Step 810 may include injecting the plurality of samples generated at step 808 into the classical optimization algorithm to augment a search performed by the classical optimization algorithm. The injection at step 810 introduces the new candidate solutions generated by the probabilistic computing device 114 into the population or solution pool maintained by the classical optimization algorithm, thereby diversifying the search and providing the classical optimization algorithm with starting points in regions of the solution space that the classical optimization algorithm may not have explored on its own. In some implementations, the injection may be performed by adding the new candidate solutions to the current population of the classical optimization algorithm. In some implementations, the injection may be performed by replacing a subset of the current population with the new candidate solutions. The classical optimization algorithm then continues its search operations using the augmented solution pool, potentially discovering improved solutions as a result of the injected candidates.

At step 812, the flow diagram 800 includes a decision step in which a determination is made whether convergence has been reached. Convergence may be assessed by evaluating whether the quality of the solutions found by the classical optimization algorithm has stabilized, whether a maximum number of iterations has been completed, or whether the improvement in the cost function value over a specified number of recent iterations falls below a tolerance threshold. If convergence has not been reached (NO), the flow diagram 800 returns to step 806, where the probabilistic model is retrained. As shown in FIG. 8, the return path from step 812 proceeds to step 806 rather than to step 804, meaning that in subsequent iterations the probabilistic model is retrained on an updated set of high-quality solutions discovered during the ongoing classical optimization, and new samples are generated and injected, without re-executing the initial high-quality solution identification of step 804. This feedback loop between steps 806, 808, 810, and 812 makes the hybrid process adaptive: as the classical optimization algorithm discovers new high-quality solutions through the augmented search, the probabilistic model is updated to reflect the evolving distribution of high-quality solutions, and the subsequent samples generated by the probabilistic computing device 114 are concentrated in progressively more refined regions of the solution space. If convergence has been reached (YES), the flow diagram 800 proceeds to step 814.

At step 814, the flow diagram 800 includes outputting a final solution. The final solution output at step 814 may be selected from the augmented set of solutions maintained by the classical optimization algorithm at the time convergence is reached. In the context of a combinatorial optimization task defined over binary variables, as described above with reference to FIG. 5, the result may be determined by selecting, from the solutions accumulated during the hybrid process, a solution having a minimum energy value. In some implementations, the final solution may reflect contributions from both the classical optimization algorithm and the probabilistic computing device 114, representing a solution of higher quality than either approach may have produced independently within the same computational budget.

FIG. 9 is a flow diagram of a technique 900 for synthesizing and deploying a quantum error correction protocol with a formal proof certificate, in accordance with certain embodiments of the present disclosure. The technique 900 depicts a sequential process that corresponds to the design-time synthesis and deployment operations described in greater detail in connection with the flow diagram 400 (FIG. 4). Steps of the technique 900 may be performed by the computing platform 102, described above with reference to FIG. 1, in conjunction with the quantum computing device 112 (FIG. 1). As shown in FIG. 9, the technique 900 includes steps 902, 904, 906, and 908.

At step 902, the technique 900 includes specifying, using a theorem prover, one or more properties of a quantum error correction protocol in a formal language. Step 902 corresponds to the generating of the formal specification at step 402 of the flow diagram 400 (FIG. 4). As described above with reference to FIG. 4, the one or more properties may include fault-tolerance of the quantum error correction protocol under a specified noise model and correctness of at least one of an encoding map or a decoding map of the quantum error correction protocol. The theorem prover, the formal language, and the types of properties that may be specified at step 902 are described in detail in connection with step 402 of FIG. 4.

At step 904, the technique 900 includes synthesizing a quantum error correction protocol and a formal proof certificate, the formal proof certificate being a machine-checkable proof that the quantum error correction protocol satisfies the one or more properties. Step 904 corresponds to the QEC protocol synthesis with embedded proof at step 404 and the generating of the formal certificate at step 406 of the flow diagram 400 (FIG. 4). As described above with reference to FIG. 4, the synthesizing at step 904 may include performing an AI-assisted proof search to generate the formal proof certificate, and the quantum error correction protocol may include at least one of a stabilizer code, a concatenated code, or a topological code. The quantum error correction protocol synthesized at step 904 may define a stabilizer measurement schedule, encoding circuits, and decoding circuits, as described in connection with step 404 of FIG. 4.

At step 906, the technique 900 includes compiling the quantum error correction protocol into a quantum circuit with the formal proof certificate embedded in the quantum circuit. Step 906 corresponds to the compiling of the QEC circuit with embedded certificate at step 408 of the flow diagram 400 (FIG. 4). As described above with reference to FIG. 4, the formal proof certificate may be embedded in the quantum circuit as metadata, as annotations within an intermediate representation of the quantum circuit, or as auxiliary classical data accompanying the quantum circuit. The output of step 906 is a proof-carrying quantum circuit, as described in connection with step 408 of FIG. 4.

At step 908, the technique 900 includes deploying the quantum circuit onto quantum computing hardware. Step 908 corresponds to the deploying of the circuit on quantum hardware at step 410 of the flow diagram 400 (FIG. 4). The quantum circuit compiled at step 906 may be deployed onto the quantum computing device 112, described above with reference to FIG. 1. As described above with reference to FIG. 4, the deployment at step 908 may include transmitting the compiled quantum circuit and its associated certificate data to classical control electronics of the quantum computing device 112 and initiating execution of the quantum error correction protocol. In some implementations, after deployment at step 908, the runtime monitoring, certificate verification, and adaptive re-synthesis operations described in connection with steps 412 through 418 of the flow diagram 400 (FIG. 4) may be performed to maintain the validity of the formal proof certificate under changing operating conditions of the quantum computing hardware.

FIG. 10 is a flow diagram of a technique 1000 for performing a computational task using a probabilistic computing device, in accordance with certain embodiments of the present disclosure. The technique 1000 depicts a sequential process that corresponds to the energy-based computational framework described in greater detail in connection with the flow diagrams 500, 600, 700, and 800 of FIGS. 5, 6, 7, and 8, respectively. Steps of the technique 1000 may be performed by the computing platform 102, described above with reference to FIG. 1, in conjunction with the probabilistic computing device 114 (FIG. 1). As shown in FIG. 10, the technique 1000 includes steps 1002, 1004, 1006, 1008, and 1010.

At step 1002, the technique 1000 includes receiving a computational task. The computational task may be any task that may be addressed by generating samples from an energy-based probability distribution. Examples of computational tasks include, but are not limited to, a combinatorial optimization task defined over binary variables (such as the MIMO decoding application described above with reference to FIG. 5), a high-dimensional integration task (such as the derivative pricing application described above with reference to FIG. 5), and a model distillation task in which a teacher model is distilled into a student model (as described above with reference to FIG. 5). The computational task received at step 1002 serves as the input from which the energy function is derived at step 1004.

At step 1004, the technique 1000 includes determining an energy function that maps configurations of variables to energy values, wherein the energy function encodes a structure of the computational task as a probability distribution. The energy function and the Boltzmann distribution it induces are described in detail in connection with the flow diagram 500 (FIG. 5). As described above with reference to FIG. 5, the energy function maps a configuration of variables to an energy value, and the probability distribution takes the Boltzmann form, such that configurations with lower energy values have higher probability. The structure of the computational task, including solutions, optima, or statistical properties, is encoded in the probability landscape of this distribution. For combinatorial optimization tasks, such as the QUBO formulation for MIMO decoding described above with reference to FIG. 5, the energy function may directly encode the objective function of the optimization problem. For high-dimensional integration tasks, the parameters of the energy function may be trained so that the probability distribution approximates a target distribution associated with the computational task, as described above with reference to FIG. 5.

At step 1006, the technique 1000 includes configuring a probabilistic computing device with parameters of the energy function, wherein the probabilistic computing device comprises hardware that natively generates samples from the probability distribution. The probabilistic computing device 114, described above with reference to FIG. 1, may be configured with the tunable parameters theta of the energy function determined at step 1004. The configuration at step 1006 corresponds to the initialization and configuration operations described in connection with step 502 of the flow diagram 500 (FIG. 5), step 602 of the flow diagram 600 (FIG. 6), step 702 of the flow diagram 700 (FIG. 7), and step 802 of the flow diagram 800 (FIG. 8), in which the probabilistic computing device 114 is prepared to generate samples from the probability distribution defined by the energy function.

At step 1008, the technique 1000 includes generating, by the probabilistic computing device, a plurality of samples from the probability distribution. The generation of samples at step 1008 may be performed using any of the sampling methods described in connection with FIGS. 5 through 8, including the Gibbs sampling process of the flow diagram 500 (FIG. 5), the simulated annealing process of the flow diagram 600 (FIG. 6), the parallel tempering process of the flow diagram 700 (FIG. 7), or the hybrid adaptive sampling process of the flow diagram 800 (FIG. 8). Each of these methods leverages the native hardware sampling capability of the probabilistic computing device 114 to generate samples from the energy-based probability distribution configured at step 1006. The plurality of samples generated at step 1008 may include samples accumulated over multiple iterations of the respective sampling process.

At step 1010, the technique 1000 includes determining a result of the computational task based on the plurality of samples. The determination at step 1010 corresponds to the output and result extraction operations described in connection with step 512 of the flow diagram 500 (FIG. 5), step 614 of the flow diagram 600 (FIG. 6), step 714 of the flow diagram 700 (FIG. 7), and step 814 of the flow diagram 800 (FIG. 8). As described above with reference to FIG. 5, for a combinatorial optimization task defined over binary variables, determining the result may include selecting, from the plurality of samples, a sample having a minimum energy value. For a high-dimensional integration task, determining the result may include computing an expectation of a function over the plurality of samples. For a model distillation task, the result may include the trained probability distribution on the probabilistic computing device 114, which serves as the student model for subsequent inference operations.

FIG. 11 is a flow diagram of a method for evaluating application instances against a resource envelope of a non-conventional computing device, in accordance with certain embodiments of the present disclosure. The technique 1100 depicts a sequential process that corresponds to the inverse analysis operations described in greater detail in connection with the data flow diagram 300 (FIG. 3). Steps of the technique 1100 may be performed by the computing platform 102, described above with reference to FIG. 1. As shown in FIG. 11, the technique 1100 includes steps 1102, 1104, 1106, and 1108.

At step 1102, the technique 1100 includes receiving, by a computing platform, a hardware specification describing capabilities of a non-conventional computing device. Step 1102 corresponds to the hardware specification 314, described above with reference to FIG. 3, serving as the input to the inverse analysis path. As described above with reference to FIG. 3, the hardware specification 314 may describe capabilities of the non-conventional computing devices 110 (FIG. 1), including the quantum computing device 112 or the probabilistic computing device 114. In some implementations where the non-conventional computing device comprises a quantum computing device, the hardware specification may include at least one of a qubit count, gate fidelities, a connectivity graph, or coherence times, as described in connection with the hardware specification 314 of FIG. 3. In some implementations, the non-conventional computing device may comprise a probabilistic computing device that natively generates samples from energy-based probability distributions.

At step 1104, the technique 1100 includes mapping the hardware specification to a resource envelope defining computational resource budgets supportable by the non-conventional computing device. Step 1104 corresponds to the resource envelope mapping operation performed by the hardware specification engine 312 during inverse analysis, as described above with reference to FIG. 3. As described above with reference to FIG. 3, the resource envelope represents the set of resource constraints, such as maximum qubit count, maximum circuit depth, minimum gate fidelity, and available coherence time, within which a computational task may be feasibly executed on the described hardware. The mapping at step 1104 translates the hardware-level capability parameters received at step 1102 into computational resource budgets against which application instances may be evaluated.

At step 1106, the technique 1100 includes evaluating a plurality of application instances against the resource envelope to identify application instances having resource requirements within the resource envelope. Step 1106 corresponds to the evaluation operation performed by the hardware specification engine 312 during inverse analysis, as described above with reference to FIG. 3. As described above with reference to FIG. 3, the evaluating at step 1106 may include querying a catalog of pre-analyzed application instances, each pre-analyzed application instance having an associated resource estimate determined by a prior forward analysis through the data flow diagram 300 (FIG. 3). In some implementations, the evaluating at step 1106 may further include ranking the identified application instances based on an expected performance quality on the non-conventional computing device, as described in connection with the hardware specification engine 312 of FIG. 3.

At step 1108, the technique 1100 includes outputting an indication of the identified application instances as computational tasks that the non-conventional computing device is capable of executing. Step 1108 corresponds to the output of the inverse analysis path in the data flow diagram 300 (FIG. 3), in which one or more identified application instances 302 that fall within the resource envelope of the described hardware are produced as output. As described above with reference to FIG. 3, the output at step 1108 may include a list of identified application instances, optionally ranked by expected performance quality, that the non-conventional computing device described by the hardware specification received at step 1102 is capable of executing.

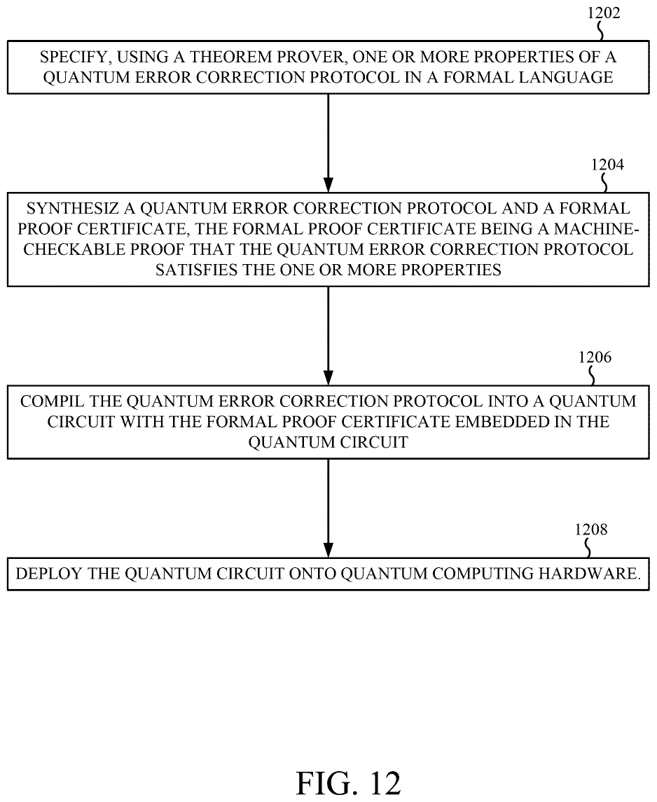

FIG. 12 is a flowchart of an example of a technique 1200 associated with non-conventional modalities of computation, in accordance with implementations of the present disclosure. The technique 1200 may represent operations performed by a system, such as the computing platform 102, described above with reference to FIG. 1, in communication with the quantum computing device 112 (FIG. 1). The technique 1200 may be performed, for example, by executing instructions stored in a memory, such as the memory 206 (FIG. 2), that, when executed by a processor, such as the processor 204 (FIG. 2), cause the system to perform the operations of the technique 1200. The steps, or operations, of the technique 1200, or another technique, method, process, or algorithm described in connection with the implementations disclosed herein, may be implemented directly in hardware, firmware, software executed by hardware, circuitry, or a combination thereof. The technique 1200 may correspond to the proof-carrying quantum error correction (PC-QEC) operations described above with reference to FIG. 4.

For simplicity of explanation, the technique 1200 is depicted and described herein as a series of steps or operations. However, the steps or operations of the technique 1200 may occur in various orders and/or concurrently. Additionally, other steps or operations not presented and described herein may be used. Furthermore, not all illustrated steps or operations may be included in an implementation in accordance with the disclosed subject matter.

At 1202, the technique 1200 includes specifying, using a theorem prover, one or more properties of a quantum error correction protocol in a formal language. The computing platform 102 (FIG. 1) may execute a formal specification module, such as the formal specification module described above with reference to FIG. 4, to express the one or more properties using a formal specification language within a theorem prover, such as Lean, Coq, or Isabelle. The one or more properties may define correctness criteria and performance bounds that a quantum error correction protocol is expected to satisfy. In some implementations, the one or more properties may include fault-tolerance of the quantum error correction protocol under a specified noise model, where the specified noise model characterizes the error behavior of a target quantum computing device, such as the quantum computing device 112 (FIG. 1). The specified noise model may include, but is not limited to, an independent depolarizing noise model, a correlated noise model, a non-Markovian noise model, or an empirically measured noise model derived from characterization of the quantum computing device 112. In some implementations, the one or more properties may include correctness of at least one of an encoding map or a decoding map of the quantum error correction protocol, where correctness of the encoding map specifies that logical qubits are faithfully represented in the physical qubit space and correctness of the decoding map specifies that measured error syndromes are mapped to appropriate recovery operations. In some implementations, the one or more properties may further include adherence to error thresholds, such as thresholds stated by the quantum threshold theorem, and compatibility with a hardware topology of the target quantum computing device.

At 1204, the technique 1200 includes synthesizing a quantum error correction protocol and a formal proof certificate. The formal proof certificate may be a machine-checkable proof that the quantum error correction protocol satisfies the one or more properties specified at step 1202. The computing platform 102 (FIG. 1) may execute an automated synthesis module to generate a candidate quantum error correction protocol together with the formal proof certificate as paired outputs. The quantum error correction protocol may define a stabilizer measurement schedule, encoding circuits, and decoding circuits that collectively implement error detection and correction on the quantum computing device 112 (FIG. 1). In some implementations, the quantum error correction protocol may include at least one of a stabilizer code, a concatenated code, or a topological code. In some implementations, the synthesizing may include performing an AI-assisted proof search to generate the formal proof certificate, where a machine learning model guides the exploration of proof strategies within the theorem prover to identify a valid formal proof that the candidate quantum error correction protocol satisfies the one or more properties. The AI-assisted proof search may reduce the computational effort of the synthesis by directing the search toward promising proof paths based on structural features of the candidate protocol and the specified properties. In some implementations, the synthesis may iterate through multiple candidate quantum error correction protocols before identifying a candidate for which a valid formal proof certificate may be constructed.

At 1206, the technique 1200 includes compiling the quantum error correction protocol into a quantum circuit with the formal proof certificate embedded in the quantum circuit. The computing platform 102 (FIG. 1) may execute a quantum circuit compiler to translate the quantum error correction protocol synthesized at step 1204 into a quantum circuit that includes gate sequences, qubit allocations, and connectivity mappings suitable for execution on the quantum computing device 112 (FIG. 1). The formal proof certificate may be embedded in the quantum circuit as metadata attached to a circuit description, as annotations in a circuit intermediate representation, or as auxiliary classical data accompanying the quantum circuit. The embedding of the formal proof certificate within the quantum circuit is analogous to proof-carrying code in classical computing systems, where compiled code is accompanied by a proof of safety properties that may be verified independently of the compilation process.

At 1208, the technique 1200 includes deploying the quantum circuit onto quantum computing hardware. The computing platform 102 (FIG. 1) may transmit the quantum circuit compiled at step 1206, together with the embedded formal proof certificate, to the quantum computing device 112 (FIG. 1) for execution. In some implementations, a lightweight certificate verification routine may be executed on classical computing hardware coupled to the quantum computing device 112 to verify the formal proof certificate prior to or during execution of the quantum circuit. The lightweight certificate verification routine may provide a computationally efficient check that the formal proof certificate remains valid, without repeating the full synthesis performed at step 1204. In some implementations, the computing platform 102 may monitor operation of the quantum computing hardware to obtain operational data after deploying the quantum circuit. The operational data may include error syndromes extracted during execution of the quantum error correction protocol. Based on the operational data, the computing platform 102 may verify whether the formal proof certificate remains valid under current operating conditions of the quantum computing hardware. In some implementations, responsive to determining that the formal proof certificate does not remain valid, the computing platform 102 may characterize a current noise model of the quantum computing hardware based on the operational data and re-synthesize an updated quantum error correction protocol and an updated formal proof certificate based on the current noise model. The updated quantum error correction protocol may be compiled into an updated quantum circuit with the updated formal proof certificate embedded therein and deployed onto the quantum computing hardware to replace the quantum circuit, as described above with reference to the adaptive re-verification and re-synthesis operations of FIG. 4.

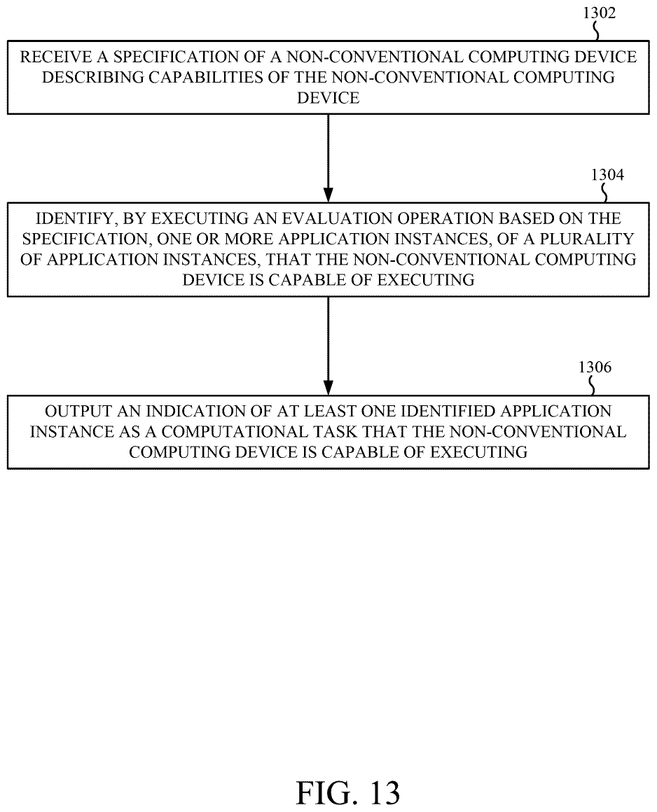

FIG. 13 is a flowchart of an example of a technique 1300 associated with non-conventional modalities of computation, in accordance with implementations of the present disclosure. The technique 1300 may represent operations performed by a system, such as the computing platform 102, described above with reference to FIG. 1, using the hardware specification engine 312 and other components described above with reference to FIG. 3. The technique 1300 may be performed, for example, by executing instructions stored in a memory, such as the memory 206 (FIG. 2), that, when executed by a processor set, such as one or more instances of the processor 204 (FIG. 2), cause the system to perform the operations of the technique 1300. The steps, or operations, of the technique 1300, or another technique, method, process, or algorithm described in connection with the implementations disclosed herein, may be implemented directly in hardware, firmware, software executed by hardware, circuitry, or a combination thereof. The technique 1300 may correspond to the inverse analysis mode of the hardware specification engine 312, described above with reference to FIG. 3.

For simplicity of explanation, the technique 1300 is depicted and described herein as a series of steps or operations. However, the steps or operations of the technique 1300 may occur in various orders and/or concurrently. Additionally, other steps or operations not presented and described herein may be used. Furthermore, not all illustrated steps or operations may be included in an implementation in accordance with the disclosed subject matter.

At 1302, the technique 1300 includes receiving a specification of a non-conventional computing device describing capabilities of the non-conventional computing device. The computing platform 102 (FIG. 1) may receive a hardware specification 314, described above with reference to FIG. 3, that characterizes the capabilities of a target non-conventional computing device in terms of quantitative resource parameters. In some implementations, the non-conventional computing device may include a quantum computing device, such as the quantum computing device 112 (FIG. 1), and the specification may include at least one of a qubit count, gate fidelities, a connectivity graph, or coherence times. The specification may further include measurement speeds, classical control bandwidth, error correction overhead, and available calibration data for the quantum computing device. In some implementations, the non-conventional computing device may include a probabilistic computing device, such as the probabilistic computing device 114 (FIG. 1), that natively generates samples from energy-based probability distributions, and the specification may include parameters such as the number of binary variables supported, a connectivity topology among variables, a sampling rate, an achievable temperature range, and a precision of tunable energy function parameters. The specification may be received from a hardware vendor, generated from empirical characterization of a physical device, or constructed from published device specifications. In some implementations, the specification may be received from the user device 104 (FIG. 1) via a graphical user interface, a command-line interface, or an application programming interface (API) exposed by the computing platform 102.

At 1304, the technique 1300 includes identifying, by executing an evaluation operation based on the specification, one or more application instances, of a plurality of application instances, that the non-conventional computing device is capable of executing. The hardware specification engine 312 (FIG. 3) may map the specification received at step 1302 to a set of resource constraints within which a computational task may be feasibly executed on the described non-conventional computing device, as described above with reference to FIG. 3. The hardware specification engine 312 may then evaluate a plurality of application instances, such as the application instance 302 (FIG. 3), against those resource constraints to identify application instances having resource requirements that fall within the capabilities described by the specification. In some implementations, the evaluation operation may include querying a catalog of pre-analyzed application instances, each pre-analyzed application instance having an associated resource estimate determined by a prior forward analysis. The catalog may accumulate resource estimates over time as additional application instances are analyzed through the forward analysis path of the data flow diagram 300 (FIG. 3), as described above with reference to FIG. 3. In some implementations, the prior forward analysis for each pre-analyzed application instance may include compiling the pre-analyzed application instance into a compiled representation suitable for execution on a non-conventional computing device (via the compiler 304 of FIG. 3), analyzing the compiled representation to determine resource requirements and performance characteristics (via the resource estimator 310 of FIG. 3), and generating a hardware specification describing hardware capabilities needed to execute the pre-analyzed application instance (via the hardware specification engine 312 of FIG. 3). The computing platform 102 may store the pre-analyzed application instance and the associated resource requirements in the catalog for subsequent use during inverse analysis operations. In some implementations, the evaluation operation may include applying a machine learning model trained to predict application suitability based on the specification, where the machine learning model receives features derived from the specification and outputs a predicted fitness score for each application instance in the catalog without performing explicit resource matching.

At 1306, the technique 1300 includes outputting an indication of at least one identified application instance as a computational task that the non-conventional computing device is capable of executing. The hardware specification engine 312 (FIG. 3) may generate and output a data structure, a report, or a user interface display that identifies the one or more application instances determined at step 1304 to be within the capabilities of the non-conventional computing device described by the specification received at step 1302. In some implementations, the computing platform 102 may rank the identified application instances based on an expected performance quality on the non-conventional computing device, providing a graduated assessment that orders the identified application instances according to how well-suited each application instance is for the described hardware, rather than providing a binary feasible-or-infeasible determination. The ranking may take into account factors such as a ratio of available resources to consumed resources, an expected error rate of the computation, and an estimated execution time relative to a usefulness threshold, as described above with reference to FIG. 3. The indication may be transmitted to the user device 104 (FIG. 1) via the network 106 (FIG. 1), or provided to another component of the computing platform 102 for further processing, such as for generating a recommendation regarding hardware procurement or for selecting a computational task for deployment on the non-conventional computing device.

In one aspect, in general, benchmarking the application performance of non-conventional modalities of computation, where an application instance is compiled into details of hardware implementation as a quantification of the computational resources required for executing the application.

In one aspect, characterizing the application utility of a given hardware architecture in a non-conventional modality of computation, where the specification or performance of a hardware device is provided as an input, and the output includes a description of the application instance(s) that can be plausibly solved by the hardware device.

In one aspect, leveraging formal methods and automated reasoning assistants to design novel algorithms and protocols in non-conventional modalities of computation. Examples include enhanced discovery of quantum algorithms and quantum error correction schemes.

In one aspect, embedding applications within the hardware architecture of non-conventional modalities of computation, leveraging the ability of probabilistic computing hardware devices for sampling from energy-based equilibrium distributions for high-dimensional integration tasks.

In one aspect, adaptively adjusting the parameters of a probability distribution realized on a probabilistic computer for approximating the properties of functions implemented on another computing platform.

In one aspect, leveraging the ability of probabilistic computing hardware to sample from structured probability distributions for solving combinatorial optimization problems, enabling efficient solutions to challenges in, for example, logistics, scheduling, and supply chain optimization.

In one aspect, utilizing probabilistic computing hardware to explore high-dimensional risk landscapes by sampling from energy-based distributions, enabling robust discrete optimization under uncertainty constraints.

In one aspect, using probabilistic computing hardware to efficiently sample from experimental design distributions in high-dimensional chemical and biological systems, providing, for example, accelerated drug discovery and materials science applications.

In one aspect, leveraging energy-based probabilistic hardware to approximate posterior distributions in Bayesian inference, enabling efficient few-shot learning and uncertainty-aware decision-making.

In one aspect, utilizing probabilistic computing hardware to enhance reinforcement learning exploration strategies by sampling from energy-based models, improving efficiency in training automated agents.

In one aspect, embedding probabilistic computing hardware within probabilistic programming frameworks to accelerate probabilistic inference in applications such as statistical modeling, risk assessment, and Bayesian deep learning.

In one aspect, leveraging probabilistic computing hardware to model energy landscapes in protein folding and molecular structure prediction, enabling, for example, efficient exploration of biologically relevant conformations.

In one aspect, utilizing energy-based probabilistic computing hardware to generate stable and optimal material structures in generative design applications, accelerating the discovery of novel materials and catalysts.

In one aspect, employing probabilistic computing hardware to generate cryptographically secure keys and analyze vulnerabilities in security protocols through structured high-dimensional sampling.

In one aspect, using probabilistic computing hardware to synthesize rare-event distributions for improving the robustness of anomaly detection models in real-world transaction data used in, for example, financial fraud detection.

Some implementations include a method, comprising: receiving, by a processor set, a specification of a non-conventional computing device describing capabilities of the non-conventional computing device; identifying, by the processor set executing an evaluation operation based on the specification, one or more application instances, of a plurality of application instances, that the non-conventional computing device is capable of executing; and outputting, by the processor set, an indication of at least one identified application instance as a computational task that the non-conventional computing device is capable of executing.

In some implementations, the non-conventional computing device comprises a quantum computing device, and the specification comprises at least one of a qubit count, gate fidelities, a connectivity graph, or coherence times.

In some implementations, the non-conventional computing device comprises a probabilistic computing device that natively generates samples from energy-based probability distributions.

In some implementations, the evaluation operation comprises querying a catalog of pre-analyzed application instances, each pre-analyzed application instance having an associated resource estimate determined by a prior forward analysis.

In some implementations, the prior forward analysis for each pre-analyzed application instance comprises: compiling the pre-analyzed application instance into a compiled representation suitable for execution on a non-conventional computing device; analyzing the compiled representation to determine resource requirements and performance characteristics; and generating a hardware specification describing hardware capabilities needed to execute the pre-analyzed application instance.

In some implementations, the method further comprises ranking the identified application instances based on an expected performance quality on the non-conventional computing device.

In some implementations, the evaluation operation comprises applying a machine learning model trained to predict application suitability based on the specification.

Some implementations include a system comprising: a processor set; and a memory storing instructions that, when executed by the processor set, cause the system to: receive a specification of a non-conventional computing device describing capabilities of the non-conventional computing device; identify, by executing an evaluation operation based on the specification, one or more application instances, of a plurality of application instances, that the non-conventional computing device is capable of executing; and output an indication of at least one identified application instance as a computational task that the non-conventional computing device is capable of executing.

In some implementations, the non-conventional computing device comprises a quantum computing device, and the specification comprises at least one of a qubit count, gate fidelities, a connectivity graph, or coherence times.

In some implementations, the evaluation operation comprises querying a catalog of pre-analyzed application instances, each pre-analyzed application instance having an associated resource estimate determined by a prior forward analysis.

In some implementations, the instructions further cause the system to rank the identified application instances based on an expected performance quality on the non-conventional computing device.

In some implementations, the instructions further cause the system to: receive an application instance defining a computational task; compile the application instance into a compiled representation comprising a lower-level representation suitable for execution on the non-conventional computing device; analyze the compiled representation to determine resource requirements and performance characteristics; and store the application instance and the resource requirements in a catalog of pre-analyzed application instances.

In some implementations, the non-conventional computing device comprises a probabilistic computing device that natively generates samples from energy-based probability distributions.

Some implementations include a system comprising: a processor set; and a memory storing instructions that, when executed by the processor set, cause the system to: receive an application instance defining a computational task intended for execution on a non-conventional computing device; compile the application instance into a compiled representation comprising a lower-level representation suitable for execution on the non-conventional computing device; analyze the compiled representation to determine resource requirements for executing the application instance on the non-conventional computing device; and generate, based on the resource requirements, a hardware specification describing hardware capabilities needed to execute the application instance.

In some implementations, the instructions further cause the system to execute the compiled representation on at least one of a processor or a simulator to validate the compiled representation prior to the analyzing.

In some implementations, the resource requirements comprise at least one of a qubit count, a gate count, a circuit depth, an error budget, or an execution time.

In some implementations, the instructions further cause the system to generate hardware specifications for a plurality of candidate hardware configurations, each candidate hardware configuration representing a different hardware architecture capable of executing the application instance.

In some implementations, the instructions further cause the system to compile the application instance by targeting at least one of gate-model quantum circuits, quantum annealing problem graphs, or measurement-based cluster state representations as the compiled representation.

In some implementations, the instructions further cause the system to perform a plurality of optimization passes during the compiling, the plurality of optimization passes comprising at least one of circuit depth minimization, qubit count minimization, error rate minimization, or connectivity-aware routing.

In some implementations, the non-conventional computing device comprises a quantum computing device, and the hardware specification comprises at least one of a qubit count, gate fidelities, a connectivity graph, or coherence times.

Some implementations include a method, comprising: specifying, using a theorem prover, one or more properties of a quantum error correction protocol in a formal language; synthesizing a quantum error correction protocol and a formal proof certificate, the formal proof certificate being a machine-checkable proof that the quantum error correction protocol satisfies the one or more properties; compiling the quantum error correction protocol into a quantum circuit with the formal proof certificate embedded in the quantum circuit; and deploying the quantum circuit onto quantum computing hardware.

In some implementations, the one or more properties comprise fault-tolerance of the quantum error correction protocol under a specified noise model.

In some implementations, the one or more properties comprise correctness of at least one of an encoding map or a decoding map of the quantum error correction protocol.

In some implementations, the synthesizing comprises performing an AI-assisted proof search to generate the formal proof certificate.

In some implementations, the quantum error correction protocol comprises at least one of a stabilizer code, a concatenated code, or a topological code.

In some implementations, the method further comprises: monitoring operation of the quantum computing hardware to obtain operational data; and verifying, based on the operational data, whether the formal proof certificate remains valid under current operating conditions of the quantum computing hardware.

In some implementations, responsive to determining that the formal proof certificate does not remain valid, the method further comprises: characterizing a current noise model of the quantum computing hardware based on the operational data; and re-synthesizing an updated quantum error correction protocol and an updated formal proof certificate based on the current noise model.

In some implementations, the verifying comprises executing a lightweight certificate verification routine on classical computing hardware coupled to the quantum computing hardware.

In some implementations, the method further comprises: compiling the updated quantum error correction protocol into an updated quantum circuit with the updated formal proof certificate embedded therein; and deploying the updated quantum circuit onto the quantum computing hardware to replace the quantum circuit.

In some implementations, the quantum error correction protocol defines a stabilizer measurement schedule, encoding circuits, and decoding circuits.

Some implementations include a system comprising: a processor; and a memory storing instructions that, when executed by the processor, cause the system to: specify, using a theorem prover, one or more properties of a quantum error correction protocol in a formal language; synthesize a quantum error correction protocol and a formal proof certificate, the formal proof certificate being a machine-checkable proof that the quantum error correction protocol satisfies the one or more properties; compile the quantum error correction protocol into a quantum circuit with the formal proof certificate embedded in the quantum circuit; and deploy the quantum circuit onto quantum computing hardware.

In some implementations, the one or more properties comprise fault-tolerance of the quantum error correction protocol under a specified noise model.

In some implementations, the instructions further cause the system to synthesize the quantum error correction protocol and the formal proof certificate by performing an AI-assisted proof search.

In some implementations, the instructions further cause the system to: monitor operation of the quantum computing hardware to obtain operational data; and verify, based on the operational data, whether the formal proof certificate remains valid under current operating conditions of the quantum computing hardware.

In some implementations, responsive to determining that the formal proof certificate does not remain valid, the instructions further cause the system to: characterize a current noise model of the quantum computing hardware based on the operational data; and re-synthesize an updated quantum error correction protocol and an updated formal proof certificate based on the current noise model.

Some implementations include a non-transitory computer-readable medium storing instructions that, when executed by a processor, cause the processor to: specify, using a theorem prover, one or more properties of a quantum error correction protocol in a formal language; synthesize a quantum error correction protocol and a formal proof certificate, the formal proof certificate being a machine-checkable proof that the quantum error correction protocol satisfies the one or more properties; compile the quantum error correction protocol into a quantum circuit with the formal proof certificate embedded in the quantum circuit; and deploy the quantum circuit onto quantum computing hardware.

In some implementations, the quantum error correction protocol comprises at least one of a stabilizer code, a concatenated code, or a topological code.

In some implementations, the instructions further cause the processor to: monitor operation of the quantum computing hardware to obtain operational data; and verify, based on the operational data, whether the formal proof certificate remains valid under current operating conditions of the quantum computing hardware.

In some implementations, the instructions cause the processor to verify by executing a lightweight certificate verification routine on classical computing hardware coupled to the quantum computing hardware.

In some implementations, responsive to determining that the formal proof certificate does not remain valid, the instructions further cause the processor to: characterize a current noise model of the quantum computing hardware based on the operational data; re-synthesize an updated quantum error correction protocol and an updated formal proof certificate based on the current noise model; compile the updated quantum error correction protocol into an updated quantum circuit with the updated formal proof certificate embedded therein; and deploy the updated quantum circuit onto the quantum computing hardware to replace the quantum circuit.

Some implementations include a method comprising: receiving a computational task; determining an energy function that maps configurations of variables to energy values, wherein the energy function encodes a structure of the computational task as a probability distribution; configuring a probabilistic computing device with parameters of the energy function, wherein the probabilistic computing device comprises hardware that natively generates samples from the probability distribution; generating, by the probabilistic computing device, a plurality of samples from the probability distribution; and determining a result of the computational task based on the plurality of samples.

In some implementations, the method further comprises training the parameters of the energy function by iteratively generating samples from the probabilistic computing device and adjusting the parameters to reduce a divergence between the probability distribution and a target distribution associated with the computational task.

In some implementations, the computational task comprises a high-dimensional integration task, and determining the result comprises computing an expectation of a function over the plurality of samples.

In some implementations, the computational task comprises a combinatorial optimization task defined over binary variables, and determining the result comprises selecting, from the plurality of samples, a sample having a minimum energy value.

In some implementations, the computational task comprises distilling a teacher model into a student model, wherein the student model is the probability distribution realized on the probabilistic computing device, and training parameters of the energy function comprises minimizing a divergence between an output distribution of the teacher model and the probability distribution.

In some implementations, the method further comprises: initializing a classical optimization algorithm on a classical processor to generate an initial set of candidate solutions for the computational task; identifying a subset of high-quality solutions from the initial set based on a cost function; training the parameters of the energy function based on the subset of high-quality solutions such that the probability distribution approximates a distribution of the high-quality solutions; and injecting the plurality of samples into the classical optimization algorithm to augment a search performed by the classical optimization algorithm.

Some implementations include a system comprising: a probabilistic computing device comprising hardware that natively generates samples from a probability distribution; and a processor coupled to the probabilistic computing device, the processor configured to: receive a computational task; determine an energy function that maps configurations of variables to energy values, wherein the energy function encodes a structure of the computational task as the probability distribution; configure the probabilistic computing device with parameters of the energy function; cause the probabilistic computing device to generate a plurality of samples from the probability distribution; and determine a result of the computational task based on the plurality of samples.

In some implementations, the processor is further configured to train the parameters of the energy function by iteratively causing the probabilistic computing device to generate samples and adjusting the parameters to reduce a divergence between the probability distribution and a target distribution associated with the computational task.

In some implementations, the processor is further configured to: execute a classical optimization algorithm to generate an initial set of candidate solutions for the computational task; identify a subset of high-quality solutions from the initial set based on a cost function; train the parameters of the energy function based on the subset of high-quality solutions; and inject the plurality of samples into the classical optimization algorithm to augment a search performed by the classical optimization algorithm.

Some implementations include a non-transitory computer-readable medium storing instructions that, when executed by a processor coupled to a probabilistic computing device, cause the processor to: receive a computational task; determine an energy function that maps configurations of variables to energy values, wherein the energy function encodes a structure of the computational task as a probability distribution; configure the probabilistic computing device with parameters of the energy function, wherein the probabilistic computing device comprises hardware that natively generates samples from the probability distribution; cause the probabilistic computing device to generate a plurality of samples from the probability distribution; and determine a result of the computational task based on the plurality of samples.

In some implementations, the computational task comprises a combinatorial optimization task defined over binary variables, and the instructions further cause the processor to determine the result by selecting, from the plurality of samples, a sample having a minimum energy value.

In some implementations, the instructions further cause the processor to train the parameters of the energy function by iteratively causing the probabilistic computing device to generate samples and adjusting the parameters to reduce a divergence between the probability distribution and a target distribution associated with the computational task.

In some implementations, the computational task comprises a high-dimensional integration task, and the instructions further cause the processor to determine the result by computing an expectation of a function over the plurality of samples.

In some implementations, the computational task comprises distilling a teacher model into a student model, wherein the student model is the probability distribution realized on the probabilistic computing device, and the instructions further cause the processor to train the parameters of the energy function by minimizing a divergence between an output distribution of the teacher model and the probability distribution.

In some implementations, the instructions further cause the processor to: initialize a classical optimization algorithm on a classical processor to generate an initial set of candidate solutions for the computational task; identify a subset of high-quality solutions from the initial set based on a cost function; train the parameters of the energy function based on the subset of high-quality solutions such that the probability distribution approximates a distribution of the high-quality solutions; and inject the plurality of samples into the classical optimization algorithm to augment a search performed by the classical optimization algorithm.

In some implementations, the computational task comprises decoding a received signal in a multiple-input multiple-output wireless communication system, and the energy function encodes a quadratic unconstrained binary optimization formulation of the decoding.

In some implementations, generating the plurality of samples comprises performing Gibbs sampling in which the probabilistic computing device updates a plurality of variables in parallel by computing, for each variable, a conditional probability based on a change in energy from flipping the variable.

In some implementations, generating the plurality of samples comprises performing simulated annealing in which the probabilistic computing device generates candidate solutions from the probability distribution at a sequence of decreasing temperatures according to a cooling schedule.

In some implementations, generating the plurality of samples comprises performing parallel tempering using a plurality of replicas at different temperatures, wherein generating the plurality of samples further comprises exchanging configurations between replicas based on a swap probability computed from energy values and temperatures of the replicas.

In some implementations, the computational task comprises a robust optimization task under uncertainty constraints, and the energy function encodes a cost function that includes a risk measure over a high-dimensional risk landscape.

Aspects can have one or more of the following advantages. They enable more efficient computational resource estimation and benchmarking for emerging computing architectures, providing insights into the suitability of non-conventional computing modalities for specific applications. They facilitate the identification of computational tasks best suited for novel hardware architectures, improving system optimization and utilization.

By integrating formal methods and automated reasoning, they enhance the reliability and correctness of quantum algorithms and error correction schemes, ensuring fault tolerance in quantum computing. The ability to embed applications within specialized computing hardware allows for significant improvements in high-dimensional integration, accelerating computations in fields such as finance, physics, and machine learning.

Probabilistic computing hardware enables efficient solutions for complex combinatorial optimization problems, reducing computational overhead in logistics, scheduling, and supply chain management. These techniques also improve decision-making under uncertainty by enabling robust discrete optimization and better exploration of risk landscapes.

Applications in scientific research, such as drug discovery and materials science, benefit from fast sampling techniques that allow for more efficient experimental design and molecular modeling. In reinforcement learning, energy-based probabilistic sampling enhances training efficiency, reducing computational costs for autonomous systems.

By integrating with probabilistic programming frameworks, these approaches accelerate probabilistic inference, benefiting statistical modeling, risk assessment, and deep learning applications. They also enable more accurate modeling of energy landscapes in protein folding, contributing to advancements in molecular biology and biophysics.

Further, the generation of cryptographically secure keys and the ability to analyze vulnerabilities in security protocols enhance cybersecurity measures. Improved anomaly detection using rare-event distribution synthesis strengthens fraud detection systems in financial and transactional data analysis.

Overall, these aspects improve computational efficiency, scalability, and adaptability across a wide range of industries, addressing challenges in optimization, machine learning, scientific discovery, security, and decision-making under uncertainty.

The techniques described herein are able to enhance computational efficiency, scalability, and adaptability across various domains by leveraging non-conventional modalities of computation. They enable precise benchmarking of application performance on specialized hardware, allowing for accurate estimation of computational resources required for execution. Additionally, these techniques facilitate the characterization of hardware capabilities, helping to determine the types of problems a given computing architecture can effectively solve.

Through the integration of formal methods and automated reasoning, these techniques improve the reliability and correctness of quantum error correction and algorithm design, ensuring robust fault-tolerant quantum computing. By embedding applications within hardware architectures, they allow for efficient high-dimensional integration, accelerating complex computations in fields such as finance, physics, and artificial intelligence.

Probabilistic computing hardware supports efficient solutions to combinatorial optimization problems, improving performance in logistics, scheduling, and supply chain management. These techniques also enable robust optimization under uncertainty, enhancing decision-making in risk-sensitive applications.

In scientific research, these methods accelerate experimental design processes, optimizing drug discovery, materials science, and molecular modeling. In machine learning and artificial intelligence, they enhance reinforcement learning strategies, improve probabilistic inference, and support generative design applications.

Moreover, these techniques provide significant benefits in cybersecurity by enabling the generation of cryptographically secure keys and identifying vulnerabilities in security protocols. They also strengthen anomaly detection systems by synthesizing rare-event distributions, improving fraud detection and risk assessment.

Overall, these approaches provide a foundation for solving complex computational problems more efficiently, enabling advancements in multiple industries while reducing computational overhead and improving real-world applicability.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2n×2n complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled c). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Quantum computing systems are inherently susceptible to errors due to decoherence and noise. Quantum error correction (QEC) techniques such as the surface code, Bacon-Shor code, and concatenated code architectures allow for fault-tolerant quantum computing. These techniques involve encoding logical qubits into multiple physical qubits and employing stabilizer measurements to detect and correct errors without directly measuring quantum states. Additionally, quantum error mitigation strategies, such as probabilistic error cancellation and extrapolation techniques, provide means to improve computational accuracy in near-term quantum devices.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state |0 [symbol] may alternatively refer to the state |1 [symbol] , and vice versa. In other words, any role described herein for the states |0 [symbol] and |1 [symbol] may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, by a processor set, a specification of a non-conventional computing device describing capabilities of the non-conventional computing device;
identifying, by the processor set executing an evaluation operation based on the specification, one or more application instances, of a plurality of application instances, that the non-conventional computing device is capable of executing; and
outputting, by the processor set, an indication of at least one identified application instance as a computational task that the non-conventional computing device is capable of executing.

2. The method of claim 1, wherein the non-conventional computing device comprises a quantum computing device, and wherein the specification comprises at least one of a qubit count, gate fidelities, a connectivity graph, or coherence times.

3. The method of claim 1, wherein the non-conventional computing device comprises a probabilistic computing device that natively generates samples from energy-based probability distributions.

4. The method of claim 1, wherein the evaluation operation comprises querying a catalog of pre-analyzed application instances, each pre-analyzed application instance having an associated resource estimate determined by a prior forward analysis.

5. The method of claim 4, wherein the prior forward analysis for each pre-analyzed application instance comprises:
compiling the pre-analyzed application instance into a compiled representation suitable for execution on a non-conventional computing device;
analyzing the compiled representation to determine resource requirements and performance characteristics; and
generating a hardware specification describing hardware capabilities needed to execute the pre-analyzed application instance.

6. The method of claim 1, further comprising ranking the identified application instances based on an expected performance quality on the non-conventional computing device.

7. The method of claim 1, wherein the evaluation operation comprises applying a machine learning model trained to predict application suitability based on the specification.

8. A system comprising:
a processor set; and
a memory storing instructions that, when executed by the processor set, cause the system to:
receive a specification of a non-conventional computing device describing capabilities of the non-conventional computing device;
identify, by executing an evaluation operation based on the specification, one or more application instances, of a plurality of application instances, that the non-conventional computing device is capable of executing; and
output an indication of at least one identified application instance as a computational task that the non-conventional computing device is capable of executing.

9. The system of claim 8, wherein the non-conventional computing device comprises a quantum computing device, and wherein the specification comprises at least one of a qubit count, gate fidelities, a connectivity graph, or coherence times.

10. The system of claim 8, wherein the evaluation operation comprises querying a catalog of pre-analyzed application instances, each pre-analyzed application instance having an associated resource estimate determined by a prior forward analysis.

11. The system of claim 8, wherein the instructions further cause the system to rank the identified application instances based on an expected performance quality on the non-conventional computing device.

12. The system of claim 8, wherein the instructions further cause the system to:
receive an application instance defining a computational task;
compile the application instance into a compiled representation comprising a lower-level representation suitable for execution on the non-conventional computing device;
analyze the compiled representation to determine resource requirements and performance characteristics; and
store the application instance and the resource requirements in a catalog of pre-analyzed application instances.

13. The system of claim 8, wherein the non-conventional computing device comprises a probabilistic computing device that natively generates samples from energy-based probability distributions.

14. A system comprising:
a processor set; and
a memory storing instructions that, when executed by the processor set, cause the system to:
receive an application instance defining a computational task intended for execution on a non-conventional computing device;
compile the application instance into a compiled representation comprising a lower-level representation suitable for execution on the non-conventional computing device;
analyze the compiled representation to determine resource requirements for executing the application instance on the non-conventional computing device; and
generate, based on the resource requirements, a hardware specification describing hardware capabilities needed to execute the application instance.

15. The system of claim 14, wherein the instructions further cause the system to execute the compiled representation on at least one of a processor or a simulator to validate the compiled representation prior to the analyzing.

16. The system of claim 14, wherein the resource requirements comprise at least one of a qubit count, a gate count, a circuit depth, an error budget, or an execution time.

17. The system of claim 14, wherein the instructions further cause the system to generate hardware specifications for a plurality of candidate hardware configurations, each candidate hardware configuration representing a different hardware architecture capable of executing the application instance.

18. The system of claim 14, wherein the instructions further cause the system to compile the application instance by targeting at least one of gate-model quantum circuits, quantum annealing problem graphs, or measurement-based cluster state representations as the compiled representation.

19. The system of claim 14, wherein the instructions further cause the system to perform a plurality of optimization passes during the compiling, the plurality of optimization passes comprising at least one of circuit depth minimization, qubit count minimization, error rate minimization, or connectivity-aware routing.

20. The system of claim 14, wherein the non-conventional computing device comprises a quantum computing device, and wherein the hardware specification comprises at least one of a qubit count, gate fidelities, a connectivity graph, or coherence times.
